(19) United States
(12) Patent Application Publication
(10) Pub. No.: US 2005/0223034 A1
(43) Pub. Date: Oct. 6, 2005

(54) Metadata for object in video

(75) Inventors: Toshimitsu Kaneko, Kanagawa (JP); Tooru Kamibayashi, Kanagawa (JP); Takeshi Nagai, Saitama (JP); Hideki Takahashi, Chiba (JP); Yasufumi Tsumagari, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/043,567

(22) Filed: Jan. 27, 2005

(30) Foreign Application Priority Data
Mar. 31, 2004 (JP) 2004-106709

(51) Int. Cl. G06F 7/00

(52) U.S. Cl. 707/104.1

(57) ABSTRACT

Metadata for an object in video includes first and second pieces of the metadata each including object property information of the object, property identification information for the object property information, and object region information indicating a position of the object in an image. If the second piece is the same as the first piece in a property of the object property information, the property identification information of the second piece is the same as the property identification information of the first piece and the second piece does not include the property in the object property information of the second piece.

### CROSS-REFERENCE TO RELATED APPLICATIONS

This application is based upon and claims the benefit of priority from the prior Japanese Patent Application No. 2004-106709 filed on Mar. 31, 2004 the entire contents of which are incorporated herein by reference.

### BACKGROUND OF THE INVENTION

1) Field of the Invention

The present invention relates to the broad realm of Internet technology and deals more specifically with hypermedia. Still more specifically, the invention relates to metadata descriptive of information to be exhibited in association with each object (e.g. figure or any other subject of interest) appearing in a motion video program, as well as to systems, methods, and computer programs for delivery of the metadata, as from a metadata distributor on the server side to a video player on the client side, for reconstruction of the received metadata, and for reproduction of the video program in synchronism with the reconstructed metadata.

2) Description of the Related Art

Hypermedia has found widespread use in recent years on the Internet as a refinement of hypertext. Written in Hypertext Markup Language (HTML), hypertext enables the user to access additional web content relating to the textural or still-pictorial matter on the display screen via website hyperlinks. Hypermedia may be envisaged as an adaptation of hypertext to motion video programs. It defines hyperlinks from the figures and other objects in a video program to associated information, either textural or pictorial, that is explanatory or illustrative of the objects. The video viewer may click on a desired object (e.g. one of the individual players in the case of a soccer game program) on the display screen. Thereupon some predefined information on that object (e.g. career of the soccer player that has been clicked) will appear on the display screen. Japanese Patent No. 3,266,278 is hereby cited as dealing with hypermedia.

Video-oriented hypermedia requires use of what is herein termed “object region data” indicative of the time-space zone occupied by each object and immediate vicinity thereof on the display screen. Object region data is obtainable by any such familiar methods as the serial image masking method of binary or greater values, the arbitrary shape coding of MPEG4 by the Moving Picture Experts Group, or the delineation of the loci of the salient points of images. (Reference may be had to ISO/IEC 14496 for more details on MPEG4.) A realization of video-oriented hypermedia demands additional data including action script indicative of a particular action to be taken, in response to the clicking of an object, to show information on that object. (The word “information” will be hereinafter spelled “information” for simplicity.) The term “metadata” as used in the context of video programs refers to all such data indicative of object regions, object properties, and action to be taken.

Video-oriented hypermedia finds application to video CDs and DVDs (digital versatile disks), on which there are prerecorded both video data and metadata. It also lends itself to use on the Internet or other computer network, from which the individual users may download both video data and metadata in streaming mode.

One of the problems encountered in the practice of hypermedia is that not all the video CDs and DVDs on the market or in users' possession today are of hypermedia format; in fact, there are incalculable numbers of non-hypermedia video disks, having video programs recorded thereon but no metadata. A solution to this problem is to make the streaming delivery, over the Internet or like computer network of client/server architecture, of the metadata that has been newly prepared to complement the preexisting video programs on the CDs and DVDs of the kind in question. The viewers are then enabled to derive the full benefits of hypermedia from their inherently non-hypermedia video disks.

As heretofore practiced, however, the streaming distribution of metadata for video programs has had some difficulties left unresolved. The metadata must be distributed in small units in anticipation of data drop-outs and in support of random access to any desired part of the metadata. The individual metadata units must be so configured as to independently perform all the purposes for which they are intended, in the face of drop-outs from other units. These requirements have resulted in redundancy, such that unnecessarily large amounts of metadata have had to be sent over the Internet for the purposes set forth above.

### SUMMARY OF THE INVENTION

It is an object of the present invention to at least solve the problems in the conventional technology.

Metadata for an object in video according to one aspect of the present invention includes first and second pieces of the metadata each including object property information of the object, property identification information for the object property information, and object region information indicating a position of the object in an image. If the second piece is the same as the first piece in a property of the object property information, the property identification information of the second piece is the same as the property identification information of the first piece and the second piece does not include the property in the object property information of the second piece.

An apparatus for distributing metadata for an object in video according to another aspect of the present invention includes a storage unit storing the metadata including first and second pieces of the metadata, and a metadata distributor sending the first and second pieces to a video player via a network. The first and second pieces of the metadata each include object property information of the object, property identification information for the object property information, and object region information indicating a position of the object in an image. If the second piece is the same as the first piece in a property of the object property information, the property identification information of the second piece is the same as the property identification information of the first piece and the second piece does not include the property in the object property information of the second piece.

An apparatus for playing video with metadata for an object in the video according to still another aspect of the present invention includes a metadata receiver receiving the metadata from a metadata distributor via a network, a metadata interpreter, and a player. The metadata includes first and second pieces of the metadata each including object property information of the object, property identification information for the object property information, and object region information indicating a position of the object in an image. The metadata interpreter obtains, if the property identification information of the second piece is the same as the property identification information of the first piece and the second piece does not include a property of the object property information of the first piece in the object property information of the second piece, the property from the object property information of the first piece, for the object property information of the second piece. The player plays the video with the first piece and the second piece including the property obtained.

A system according to still another aspect of the present invention includes the metadata distributing device and the video playing device according to the invention, which are connected via a network.

A method according to still another aspect of the present invention is of distributing metadata for an object in video. The metadata includes first and second pieces each including object property information of the object, property identification information for the object property information, and object region information indicating a position of the object in an image. The method includes sending the first and second pieces to a video player via a network. If the second piece is the same as the first piece in a property of the object property information, the property identification information of the second piece is the same as the property identification information of the first piece and the second piece does not include the property in the object property information of the second piece.

A method according to still another aspect of the present invention is of playing video with metadata for an object in the video. The method includes receiving the metadata from a metadata distributor via a network. The metadata includes first and second pieces each including object property information of the object, property identification information for the object property information, and object region information indicating a position of the object in an image. The method also includes obtaining, if the property identification information of the second piece is the same as the property identification information of the first piece and the second piece does not include a property of the object property information of the first piece in the object property information of the second piece, the property from the object property information of the first piece, for the object property information of the second piece; and playing the video with the first piece and the second piece including the property obtained.

The computer program product according to still another aspect of the present invention causes a computer to perform the method according to the present invention.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a hypermedia system of client/server architecture well adapted for carrying out the concepts of the present invention with use of metadata of reduced redundancy;

FIG. 2 is a pictorial representation explanatory of each object, or object region, that appears in a video program being played, and of information that is displayed upon clicking of the object region;

FIG. 3 is a diagram explanatory of how an object region during a certain length of time is divided into a series of object region segments and translated into a series of object region data units;

FIG. 4 is a diagram explanatory of the data configuration of each object metadata unit;

FIG. 5 is a diagram explanatory of the data configuration of the object property information section of the object metadata unit of FIG. 4;

FIG. 6 is a diagram explanatory of the data configuration of the ID section of the object metadata unit of FIG. 4;

FIG. 7 is a table listing examples of object properties included in the object property information section of the object metadata unit of FIG. 4;

FIG. 8 is a diagram showing the ID section of the object metadata unit which is similar to that of FIG. 6 except that the media ID subsection is omitted;

FIG. 9 is a diagram showing an object metadata unit similar to FIG. 4 except that the object property information section is omitted;

FIG. 10 is a diagram showing the object property information section of each object metadata unit which is similar to that of FIG. 5 except that the action script subsection is omitted;

FIG. 11 is a diagram showing the object property information section of each object metadata unit which is similar to that of FIG. 5 except that the object marking information subsection is omitted;

FIG. 12 is a diagram explanatory of how different sets or series of object metadata units for three different camera-angle and language versions of a video program are serially arranged in the order of the timestamps on the metadata units to form a single object metadata stream preparatory to delivery to the video player of FIG. 1;

FIG. 13 is a flowchart of On-Demand Metadata Delivery Program installed on the metadata distributor of FIG. 1 for packet-by-packet delivery of object metadata on demand from the video player;

FIG. 14 shows an example of Access Point Table which is stored on the metadata distributor of FIG. 1 in order to assure high speed access to any required point on the object metadata stream to be delivered to the video player;

FIG. 15 is a diagram explanatory of how a relatively small set of object metadata is contained in a packet for delivery from metadata distributor to video player of FIG. 1;

FIG. 16 is a diagram explanatory of how a larger set of object metadata is divided into two consecutive packets for delivery from metadata distributor to video player of FIG. 1;

FIG. 17 is a diagram explanatory of intercommunications between the metadata distributor and video player of FIG. 1 for each session of hypermedia video reproduction;

FIG. 18 is a flowchart of Metadata Decode Program which is installed on the video player of FIG. 1 to dictate its operation upon receipt of the object metadata from the metadata distributor;

FIG. 19 is a flowchart of a subroutine of the Object Metadata Decode Program, FIG. 18, for creating Object Property Tables;

FIG. 20 shows an example of Action Script Table listing the action IDs and the filenames of the corresponding action scripts;

FIG. 21 is a flowchart of a program installed on the video player of FIG. 1 to prescribe its operation in response to the viewer clocking of an object;

FIG. 22 is a pictorial representation of explanatory nature showing how a telop is exhibited on a display screen of the video player of FIG. 1 as a kind of object marking;

FIG. 23 is a diagram similar to FIG. 3 but explanatory of how a displaceable telop region during a given period of time is translated into a series of object region data units;

FIG. 24 is a representation of the configuration of the object marking information included in the object metadata indicative of an upwardly traveling telop;

FIG. 25 is a telop representation similar to FIG. 22 but explanatory of video player action in response to the view clicking of some word or words, or character or characters, of the telop being exhibited on the display screen;

FIG. 26 is a diagram similar to FIGS. 3 and 23 but showing the telop zone of FIG. 25 and the group of telop words shown clicked in the same figure;

FIG. 27 is a pictorial representation of explanatory nature showing, as an example of object marking, the outlining of text on the display screen like a cartoon balloon in order to enable the viewer to discern which object the displayed text is associated with;

FIG. 28 is a diagram explanatory of the configuration of object marking information for the outlined text display of FIG. 27;

FIG. 29 shows several different kinds of alternative outlines for use in the text display of FIG. 27;

FIG. 30 shows one of the outlines of FIG. 29 together with some preselected points thereon the coordinate positions of which are to be set forth as object region data in order to determine the size and position of the outline on the display screen;

FIG. 31 is a flowchart of modified Metadata Decode Program which is to be introduced into the video player of FIG. 1 in substitution for the first disclosed Metadata Decode Program of FIG. 18;

FIG. 32 is a flowchart of a subroutine of the modified Object Metadata Decode Program, FIG. 31, for reconstruction of those object metadata units from which some object property information has been omitted;

FIG. 33 is a flowchart of another program to be built into the video player of FIG. 1 in substitution for that of FIG. 21 in order to dictate the steps to be followed by the video player when the viewer clicks on an object region;

FIG. 34 is a pictorial representation of a fixed telop zone, given as an example of object region permitting omission of object region data according to the invention;

FIG. 35 is a diagram similar to FIG. 23 but explanatory of how a fixed telop region during a given period of time is translated into a series of object region data units;

FIG. 36 is a diagram similar to FIG. 9 but explanatory of a further example of data configuration in each unit of object metadata from which object region data has been omitted according to the invention;

FIG. 37A is a flowchart of a first half of modified Metadata Decode Program to be installed on the video player of FIG. 1 in substitution for the first disclosed Metadata Decode Program of FIG. 18 to dictate the operation of the video player upon receipt of the object metadata from the metadata distributor,

FIG. 37B is a flowchart of the remainder of the modified Metadata Decode Program of FIG. 37A;

FIG. 38 is a flowchart of a subroutine of the modified Metadata Decode Program, FIGS. 37A and 37B, for creation of Object region Table;

FIG. 39 shows an example of the Object region Table set forth with reference to FIG. 38; and

FIG. 40 is a pictorial representation of an Enhanced DVD having prerecorded thereon object metadata as taught by the present invention, together with a block-diagrammatic representation of the configuration of the complete data stored thereon.

### DETAILED DESCRIPTION

Exemplary embodiments of metadata, a metadata distributor, a video player, a system including the metadata distributor and the video player, and methods of distributing metadata and playing video relating to the present invention will be explained in detail below with reference to the accompanying drawings.

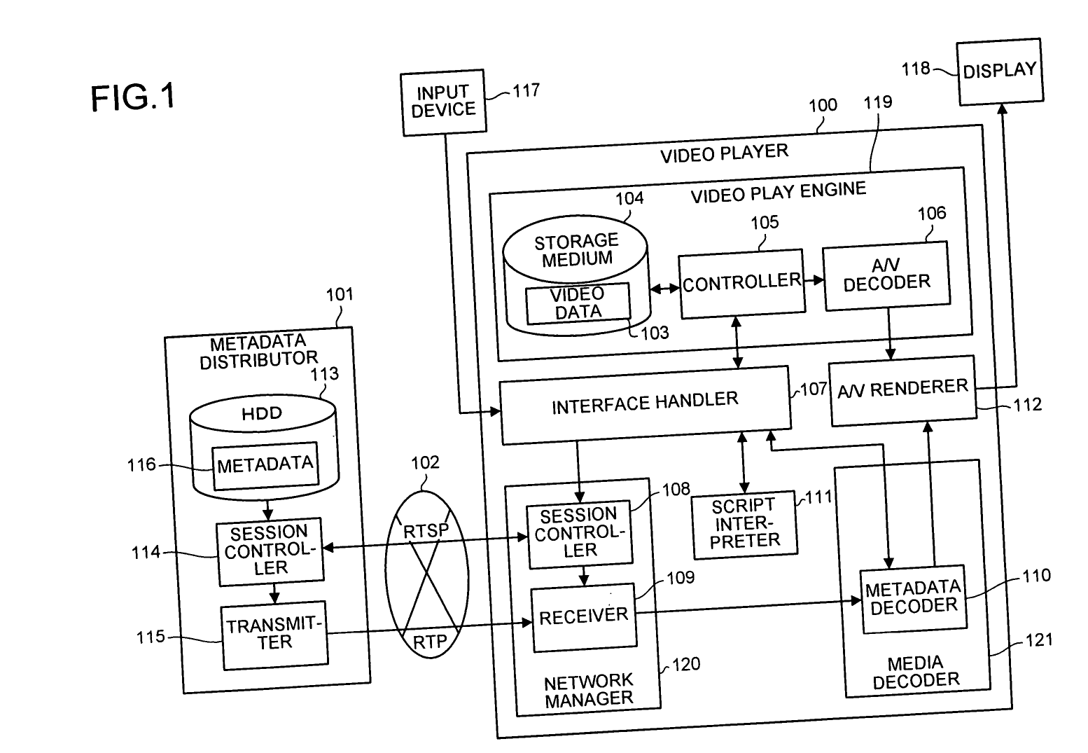

Shown in FIG. 1 as a representative embodiment of at least some aspects of the invention, the client/server architecture comprises, as has been mentioned above, the video player 100 on the client side and the metadata distributor 101 on the server side. The view player 100 and metadata distributor 101 are interconnected via the computer network 102 such as the Internet. The metadata distributor 101 distributes metadata over the network 102. Downloading the metadata from the network 102, the client's video player 100 reproduces a desired video program in synchronism with the received metadata, in order to enable the viewer to click on a desired object on the display screen to see some predefined information on the object.

For delivering metadata on demand from each client, the metadata distributor 101 comprises a hard disk drive (HDD) 113, a session controller 114, and a transmitter 115. The HDD 113 includes hard disks storing the metadata to be delivered to the clients, although other storage media could be employed as well, examples being semiconductor memories and magnetic tape. The metadata stored here is associated with, or complementary to, the inherently non-hypermedia video programs to be reproduced by the video player 100, as will be detailed presently.

The session controller 114 is designed for exchange of control data with the video player 100 via the network 102 for each session of metadata delivery. The transmitter 115 sends the metadata, retrieved from the HDD 113 via the session controller 114, to the video player 100 via the network 102. The transmitter 115 is equipped to schedule metadata delivery so that the metadata requested by the client may be sent in proper timing.

Inputting the streaming metadata from the metadata distributor 101, the video player 100 reproduces video data and processes the metadata in synchronism with the video reproduction. Thus the video player 100 gains hypermedia functions in addition to those normally associated with simple video reproduction. In terms of hardware the video player 100 comprises a player engine 119, an interface handler 107, an audio/video renderer 112, a network manager 120, a media decoder 121, a script interpreter 111, an input device 117, and a display 118.

The player engine 119 includes known means for reproduction of a video program 103 stored, either digitally or otherwise, on any such storage medium 104 as DVD, video CD, hard disk, video tape, or semiconductor memory. The storage medium 104 also stores metadata according to the invention.

The player engine 119 is shown as additionally comprising a controller 105 and an audio/video decoder 106. The controller 105 controls data read out from the storage medium 104. More specifically, in response to user instructions entered on the input device 117 and delivered through the interface handler 107, the controller 105 dictates the start and stop of video retrieval from the storage medium 104 as well as random access to any desired point thereon.

The video program to be reproduced may be recorded compressed on the storage medium 104. Then the audio/video decoder 106 will reconvert the incoming video program into the original form. The video program on the storage medium 104 may be accompanied by audio data, as is usually the case. In that case the audio/video decoder 106 will separate the video and the audio data and decode them independently.

The interface handler 107 controls interfaces between all such component modules of the video player 100 as the player engine 119, network manager 120, metadata decoder 110, script interpreter 111, and audio/video renderer 112.

Additionally, the interface handler 107 is coupled to the input device 117 to receive therefrom each input event and deliver the same to any appropriate module. The audio/video renderer 112 processes the decoded video and audio data from the audio/video decoder 106 for rendering on the display 118. Possibly, video signals may be supplied not only from the audio/video decoder 106 but from the metadata decoder 110 too. In that case the audio/video renderer 112 synthesizes the video signals from both audio/video decoder 106 and metadata decoder 110 and delivers the resulting composite video signals to the display 118. The renderer 112 coacts with the controller 105 and decoder 106 for actual video reproduction as hypermedia.

The network manager 120 comprises a session controller 108 and a receiver 109. The session controller 108 exchanges control data with the metadata distributor 101 via the network 102. The control data sent from video player 100 to metadata distributor 101 includes requests for media or metadata, for session start or session end, for metadata delivery start, and for pause in metadata delivery. The control data sent from metadata distributor 101 to video player 100, on the other hand, includes status data such as OKs and errors.

In response to a metadata request from the video player 100, the metadata distributor 101 sends the desired metadata to the video player in streaming mode via the network 102. The receiver 109 of the network manager 120 inputs the streaming metadata and sequentially transfers the same to the metadata decoder 110 of the media decoder 110.

The metadata decoder 110 analyzes the incoming metadata as taught by the instant invention. Referring to the timestamps of the video data being processed by the audio/video decoder 106, the metadata decoder 110 decodes the required metadata in synchronism with the video data. Further, in response to the object marking information (yet to be detailed) which is included in the metadata, the metadata decoder 110 creates video data needed for marking the object regions, as by masking, and delivers such data to the audio/video renderer 112.

Additionally, the metadata decoder 110 creates object property tables listing correlations between object property information and identification data. For those object metadata units from which object property information has been omitted either in part or in whole, the metadata decoder 110 relies on the object property tables for recovering the missing object property information from the object metadata units bearing the same IDs, as will become better understood as the description progresses.

The metadata decoder 110 has still another function that manifests itself when the viewer specifies some object by clicking or like input event. Ascertaining the object thus specified, the metadata decoder 110 obtains an action command such as that for exhibition of predefined additional information pertaining to the specified object. The obtained action command is sent to the script interpreter 111 via the interface handler 107. A yet further function of the metadata decoder 110 is to erase from the memory any metadata that has become obsolete or unnecessary. The metadata decoder 110 relies for the last mentioned function upon the timestamps included in the metadata and those of the video data being played.

The script interpreter 111 interprets and implements the command specified by the action script (yet to be detailed) included in the object metadata according to the invention. The script to be executed when the viewer specifies an object is sent from the metadata decoder 110 to the script interpreter 111 via the interface handler 107.

The input device 117 may take the form of one or more of such known devices as a mouse, a touchpad, and a keyboard. The display 118 may be of either plasma, light-emitting diode, liquid crystal, or electroluminescent construction.

High reliability is a prerequisite of communication protocol for use in data delivery between video player 100 and metadata distributor 101 via the network 102. An example of protocol meeting this requirement is Real-Time Streaming Protocol/Transmission Control Protocol/Internet Protocol (RTSP/TCP/IP). Real-time Transport Protocol/User Datagram Protocol/Internet Protocol (RTP/UDP/IP) is preferred for metadata delivery from distributor 101 to video player 100 by reason of swiftness of data transmission. The required two-way data transfer between video player 100 and metadata distributor 101 may take place via either the same network or separate ones.

In practice both video player 100 and metadata distributor 101 may be of the familiar computer hardware comprising a central processor unit (CPU), memories including a read-only memory (ROM) and a random access memory (RAM), a HD drive, external storage means such as a CD or DVD drive, a display, and input means such as a keyboard and a mouse. Alternatively, the video player 100 may be a commercial device dedicated solely for reproduction of DVD or other video disks.

The video reproduction program for use on the video player 100 and the metadata distribution program for use on the metadata distributor 101 may both be supplied in the form of installable or executable files. Such files may be recorded on computer-readable storage media such as CD-ROMs, flexible magnetic disks, CD-Rs, or DVDs.

A further, and far more large-scale, application of the invention is a computer network as typified by the Internet. The noted video reproduction program and metadata distribution program may both be installed on a computer connected to the network, thereby permitting the individual users to download the programs. Or the video reproduction and metadata distribution programs may be presented or distributed over the network.

The video reproduction program and metadata distribution program according to the invention are both of modular configuration set forth with reference to FIG. 1. As each program is read out from any of the noted storage media and executed on the main storage device, the modules are generated thereon.

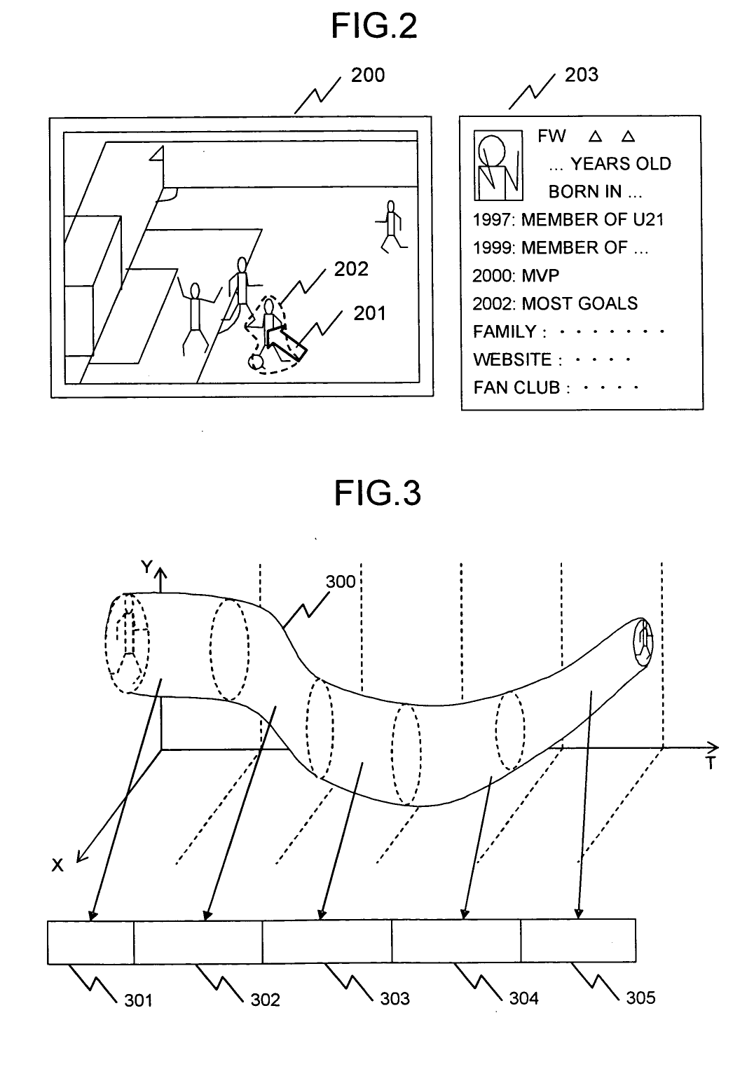

FIG. 2 is explanatory of how each video program is played back as hypermedia on the video player 100, FIG. 1, with the exhibition, as desired, of ancillary program-related information supplied by metadata from the metadata distributor 101. The video program being shown on a display screen 200 has been retrieved from the storage medium 104 loaded in the video player 100. Individual figures and other subjects of interest appearing in this video program (e.g. individual players in the case of a soccer game shown) are herein generally referred to as objects. One soccer player and his or her immediate vicinity (i.e. one object region) on the display screen 200 is shown encircled by a dotted line and labeled 202.

As the viewer points this object region with a cursor 201 and clicks, information relating to that object (e.g. the career of, and other personal information on, the clicked soccer player) will be exhibited as at 203. The object information thus exhibited has been encoded in the metadata stored on the HDD 113, FIG. 1, of the metadata distributor 101, from which the metadata has been delivered as aforesaid to the video player 100 via the network 102. The action to be performed by the video player 100 upon clicking of the object region 202 (i.e. the action of exhibiting the related object information in the case of FIG. 2) is specified by the noted action script which is included in the metadata in the metadata distributor 101 along with the object data.

The metadata for use in the practice of this particular embodiment of the invention includes both object region data indicative of the zones of the objects appearing in each video program recorded on the storage medium 104 of the video player 100, and object property data indicative of how each object is marked or indicated on the display screen by the video player 100 and of the action to be taken by the video player when that object, or object region, is clicked by the viewer.

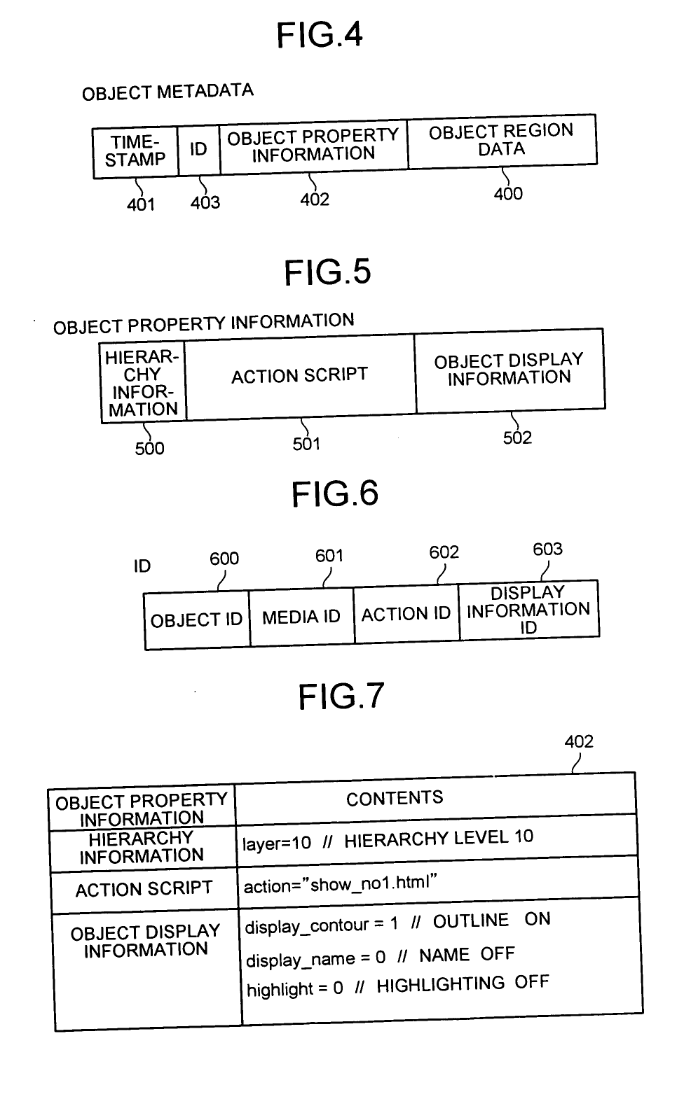

Reference may be had to FIG. 3 for a more detailed discussion of the object region data. This figure indicates how the object region 300 travels through the three-dimensional space defined by the horizontal axis X, vertical axis Y, and time axis T. The object region is sampled at prescribed time intervals of, say, from 0.5 to 1.0 second, and each sample is converted into one set of object region data. In FIG. 3, for example, the object region 300 is sampled five times during the time-space continuum shown, and the thus-defined five segments of the object region are represented by as many units of object region data 301-305. These units of obtain zone data constitute parts of the object metadata to be explained later with reference to FIGS. 4-12.

Object regions may be converted into object region data by some such known method as shape coding by MPEG-4 or the time-space zone descriptors of MPEG-7. The MPEG-4 shape coding method and MPEG-7 time-space descriptor method are alike in lessening data amounts by taking advantage of the time correlations of object regions. Consequently, these methods inherently possess the shortcoming that data may become undecodable, or that, in the event of a data dropout at a certain moment in time, not only that data but the neighboring data may also become undecodable. These shortcomings will present no serious problem at all in the illustrated embodiment of the invention, in which each lasting object region is divided into a series of separately encoded segments. The encoding of the successive objective zone segments expedites random access to any such segments and mitigates the effects of partial data dropouts.

FIG. 4 is a schematic representation of data configuration in one unit of object metadata for use in this embodiment of the invention. Each object metadata unit is divided into a timestamp section 401, an ID section 403, an object property information section 402, and an object region data section 400.

As has been set forth with reference to FIG. 3, the object region data section 400 bears object region data representative of one object region over a preassigned period of time. The time position of the object region data on this section 400 with respect to the video program is indicated by the timestamp on the timestamp section 401. Since the object region data on the section 400 represents the object region during the preassigned length of time, the timestamp normally indicates only the starting moment of that time span. As required, however, there may additionally be recorded the time span and ending moment of the object region data on the section 400.

The object property information on the section 402 indicates how the associated object is marked off (as by contouring, labeling or highlighting on the display screen, and the action to be taken by the video player 200 when the object is clicked. More specifically, as shown in FIG. 5, the object property information section 402 is subdivided into a hierarchy information subsection 500, an action script subsection 501, and an object marking information subsection 502.

The hierarchy information on the subsection 500 of the object property information section 402 represents the hierarchical rank of each object in cases where a plurality of object regions overlap one upon another on the display screen. One of such overlapping objects must be chosen as the one that has been specified by the view, it being undesirable that information concerning all the overlapping objects be displayed at one time. An example of hierarchy information is a series of numbers from zero to 255. The smaller the hierarchy number, the more is the object positioned in the foreground of the scene being shown on the display screen. Thus does the hierarchy information makes it possible to choose, for example, the foremost object of the scene when the viewer clicks on the overlapping parts of two or more object regions.

The action script on the subsection 501 of the object property information section 402 specifies one of the possible actions to be taken by the video player 100 upon clicking of an object Such possible actions may include an exhibition of an HTML file, a jump to another video program or to a different scene of the program now in progress, or an execution of an application program. Alternatively, the action script may simply indicate the name of a script file on which is specified the actual action to be conducted. The script file indicated by the script may be cross-referenced by the script interpreter 111, FIG. 1, for implementation of the action set forth in the script file.

The object marking information on the subsection 502 of the object property information section 402 determines how the objects, or object regions, are marked or visually indicated on the display screen. For example, an object region may be either highlighted by a difference in brightness, bound off by an outline or contour, or labeled by a name tag attached in the neighborhood of the object The object marking information specifies one of these marking methods and additionally contains the parameters for such marking. FIG. 7 gives an example of object property information on the section 402 of each object metadata unit.

With reference back to FIG. 4 the ID section 403 of each object metadata unit bears data identification of the object property information on the section 402. As indicated in more detail in FIG. 6, the ID section 403 is subdivided into an object ID subsection 600, a media ID subsection 601, an action ID subsection 602, and a marking information ID subsection 603. The action ID and marking information ID provide information identification of these two object properties; the action ID, action identification information; the marking information ID, marking identification information; and the object ID, object identification information.

The object ID on the ID subsection 600 uniquely identifies each object appearing in the video program. However, different object IDs may be assigned to one figure or other subject if such one figure or other subject is to be dealt with as different objects.

The media ID on the ID subsection 601 specifies the video program for which the object metadata is intended. Some video programs are so made that, like the multiangle features (yet to be described) of some DV Ds, different images are presented depending upon which of the two or more different languages to be spoken or which of two or more different camera angles are chosen by the viewer. When the video program on the storage medium 104, FIG. 1, is of this type, the media ID specifies which spoken language or which camera angle the object metadata is effective for.

The action ID on the ID subsection 602 is identification information for the action script on the object property information subsection 501. The marking information ID on the ID subsection 603 is identification information for the object marking information on the object property information subsection 502.

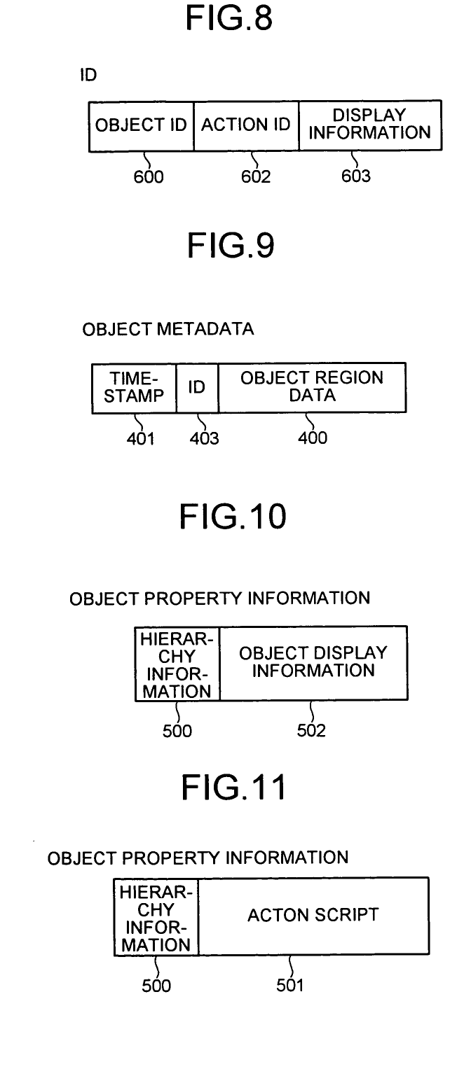

Notwithstanding the showing of FIG. 6, however, not all of the object ID, media ID, action ID, and marking information ID are always necessary on the ID subsections 600-603. For example, if only one video program is recorded on the storage medium 104, the media ID will be unnecessary. If the action script and the object marking information are in one-to-one correspondence, the ID data of only either will be required. The action ID and marking information ID will both be unnecessary if the action script and object marking information are predetermined for each object. FIG. 8 shows the object metadata ID section as having no media ID subsection but having only the object ID subsection 600, action ID subsection 602, and marking information ID subsection 603.

It is among the features of the present invention that the ID section 403, FIG. 4, of each object metadata unit is so utilized as to reduce the amount of data sent from metadata distributor 101 to video player 100. If the same action is to occur when the viewer clicks on the same object on the display screen, the action script on the subsection 501, FIG. 5, of the object property information section 401 of each object metadata unit is the same for each object. As has been discussed with reference to FIG. 3, the object region for each mobile object is divided into a series of segments, and each object region segment encoded into one unit of object metadata shown in FIG. 4. Thus each object is represented by a series of object metadata units during a given length of time.

All such object metadata units will contain the same action script if, as has been assumed above, the video player 100 is to take the same action in response to the viewer clicking of the same object. In that case, according to the teachings of the present invention, the same object ID may be used for the whole series of object metadata units for the same object, and the object property information under consideration may be omitted from all but at least one of the series of object metadata units. The amount of metadata delivered from metadata distributor 101 to video player 100 will be significantly reduced in this manner.

FIG. 9 is explanatory of data configuration in each unit of object metadata in the case where the object property information is omitted. The modified object metadata unit is constituted of the timestamp section 401, ID section 403, and object region data section 400, but has no object property information section shown at 402 in FIG. 4, resulting in a corresponding decrease in data amount.

For each series of object metadata units bearing the same ID there must be at least one where the object property information section 402 is left intact. Inputting the other object metadata units from which object property information has been omitted, the video player 100 will then be capable of regaining the action script and other object property information by referring to the object metadata unit from which the object property information has not been omitted. Object marking information may be regained likewise by the video player 100.

Unlike the showing of FIG. 9, however, not the entire object property information may be omitted from each object metadata unit. Only part of the object property information may be omitted instead, such as the action script on the subsection 501, FIG. 5, or the object marking information on the subsection 502. FIG. 10 shows one such modified object property information section which is similar to that of FIG. 5 but which has no action script subsection 501. FIG. 11 shows another such modified object property information section from which the object marking information section has been omitted.

According to a further feature of the invention, by use of the same ID, only changes in the object property information included in the preceding object metadata unit may be delivered from metadata distributor 101 to video player 100. For most efficient delivery of successive object metadata units that differ only slightly in object property information, the same ID may be used for such units, and only the differences in object properties may be sent to the video player.

Receiving such object metadata units, the video player may store the object property information for each ID. The stored object property information may be renewed upon receipt of object property information that requires such renewal. The video player 100 may then perform the required operations as dictated by the object information stored for each ID.

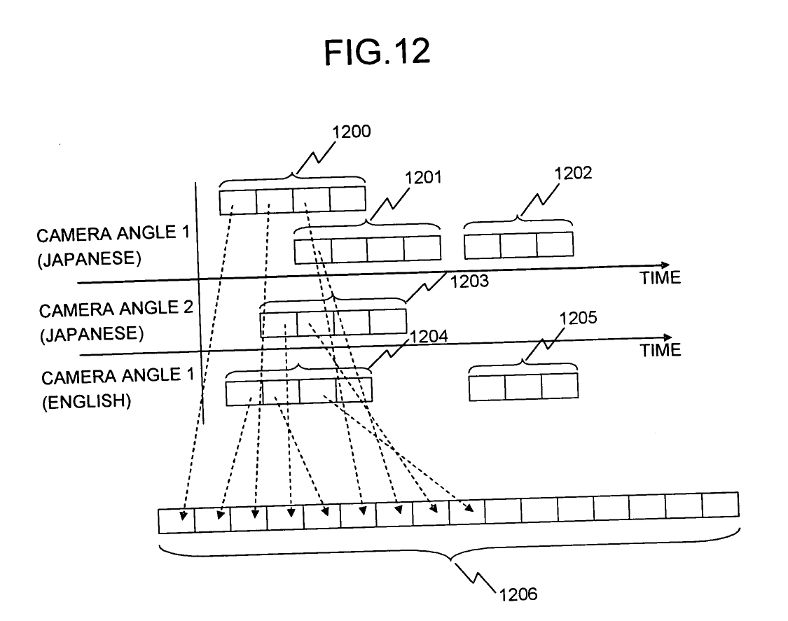

It is also desirable for most efficient metadata delivery that the object metadata units be arranged on the HDD 113, FIG. 1, of the metadata distributor 101 in the order of the timestamps. FIG. 12 is explanatory of a stream of object metadata units arranged in the order of their timestamps. This figure is drawn on the assumption that the video program associated with the object metadata stream has two versions of different camera angles, designated Camera Angle I and Camera Angle II, which may be switched one from the other to see different images or scenes on the display screen. It is also assumed that two different languages (e.g. Japanese and English) are offered for the viewer's choice, with different object metadata prepared for each language.

Referring now more specifically to FIG. 12, object metadata sets or series 1200, 1201 and 1202 are all for the Camera Angle I and Japanese-language version; object metadata set 1203 for the Camera Angle I and Japanese-language version; and object metadata sets 1204 and 1205 for the Camera Angle I and English-language version. The six representative sets of object metadata 1200-1205, each constituted of several object metadata units explained with reference to FIG. 3, correspond one to each object in the video program.

The horizontal axes in FIG. 12 represent the lapse of time in the video program. The six sets of object metadata 1200-1205 are shown positioned in time relationship to the appearances of the associated objects in the program. All these sets of object metadata constitute in combination the object metadata stream generally designated 1206, which in fact is a serial arrangement of the object metadata units in the order of their timestamps.

Out of this object metadata stream 1206, the video player 100 needs only those sets of object metadata units which meet the viewer settings of camera angle and language. For example, if Camera Angle II is chosen, the object metadata set 1203 is needed during the time period of FIG. 12 whereas the other object metadata sets 1200-1202, 1204 and 1205 are not. Therefore, supplied with the camera angle and language settings from the video player 100, the metadata distributor 101 may select only the required object metadata sets for delivery to the video player.

Possibly, however, the viewer may frequently change the camera angle and/or language settings. This possibility is a justification of thorough delivery of the complete object metadata stream 1206 from metadata distributor 101 to video player 100. The video player 100 may then be so constructed as to select the required set or sets of object metadata units for each camera angle and language setting.

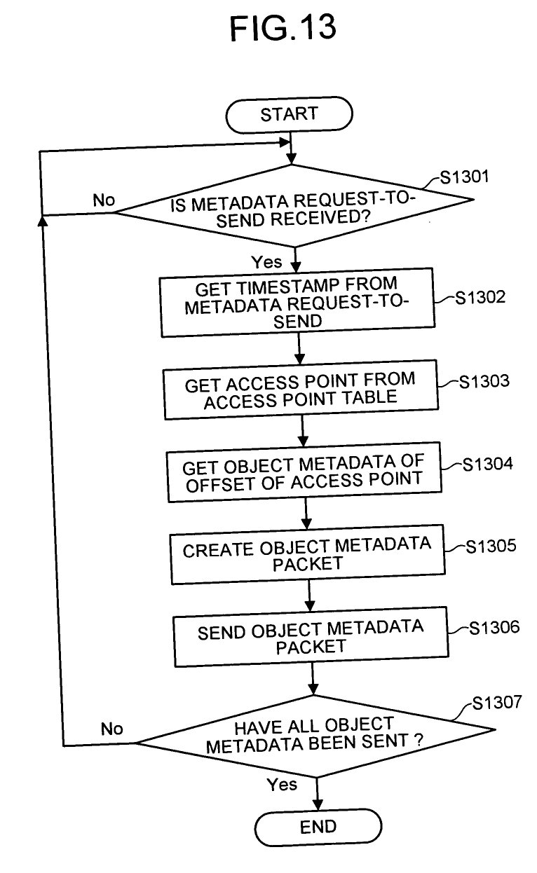

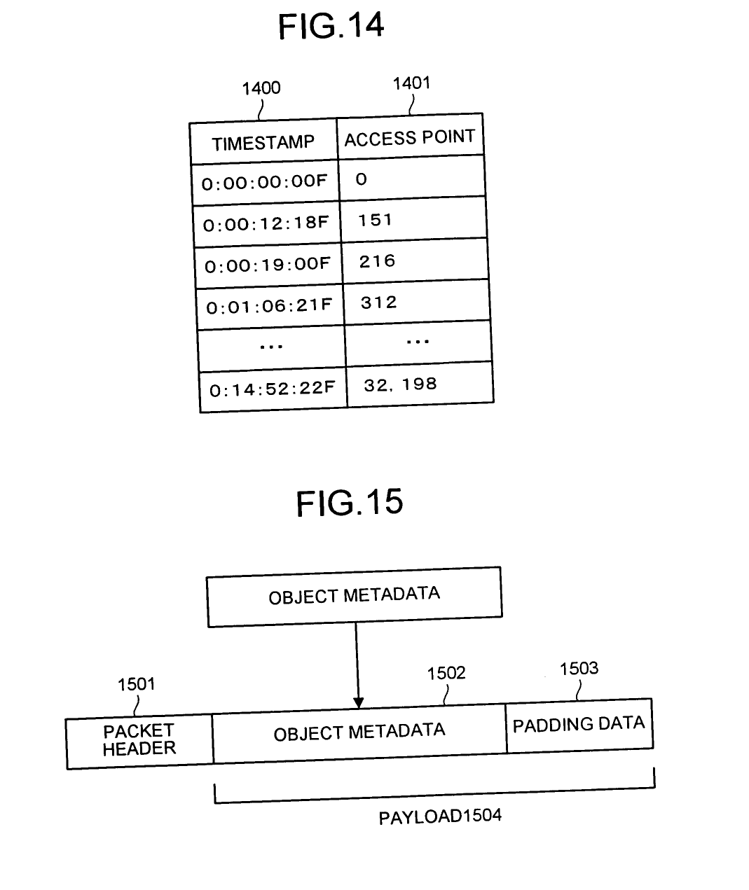

Flowcharted in FIG. 13 is On-Demand Metadata Delivery Program by which object metadata is delivered from metadata distributor 101 on demand from any client computer in the network. At a logical node S1301 on this On-Demand Metadata Delivery Program the session controller 114 of the metadata distributor 101 is awaiting a metadata request-to-send, which includes the object metadata timestamp 401, FIG. 4, from the video player 100. Upon receipt of a metadata request-to-send (answer “yes” to the node S1301), the session controller 114 causes the transmitter 115 to obtain the timestamp of the requested metadata from the metadata request-to-send at the block S1302. Further, at the next block S1303, the transmitter 115 obtains the access point on the object metadata stream corresponding to the obtained timestamp, by referring to Access Point Table described hereinbelow with reference to FIG. 14.

If the view starts the reproduction of a video program from its very beginning, the object metadata stream may be delivered from metadata distributor 101 to video player 100 from its beginning. However, as each video program is random-accessed, so must be the object metadata stream for that program. The object metadata must then be delivered from any required point intermediate the beginning and end of the complete object metadata stream. The Access Point Table is preformed and introduced into the HDD 113, FIG. 1, of the metadata distributor 101 according to the invention in order to assure high speed access to any required point on the object metadata stream.

A closer study of FIG. 14 will reveal that the Access Point Table indicates correlations between the timestamps 1400 of the video program and the access points on the object metadata stream. The access points 1401 represent the offsets of the object metadata from the beginning of the object metadata stream.

With reference back to FIG. 13 the transmitter 115 of the metadata distributor 101 obtains the object metadata at the required access point at the block S1304, creates a packet or packets of the object metadata to be sent at the block S1305, and sends the object metadata packet to the video player 100 at the block S1306.

The timestamps of random-accessed points on the video program may not be listed on the Access Point Table. In such cases an access point corresponding to a timestamp close to the unlisted timestamp may first be ascertained, and where the object metadata starts to be delivered may be determined by referring to the object metadata timestamps in the neighborhood of that access point. Alternatively, the metadata distributor may be programmed to search the Access Point Table for a timestamp earlier than the random-accessed point on the video program and to start metadata delivery at that earlier access point.

The block S1306 of the On-Demand Metadata Delivery Program is followed by another logical node S1307. which asks if all the required object metadata has been sent. The answer “no” to this query directs the program back to the block S1301, so that the steps of S1301-S1306 are cyclically repeated until all the necessary object metadata is delivered to the video player 100.

As has been mentioned in connection with the blocks 1305 and 1306 of the On-Demand Metadata Delivery Program, the object metadata is sent from metadata distributor 101 to video player 100 in the form of a packet or packets. FIG. 15 is explanatory of packet configuration for an object metadata set of relatively small size. It will be noted that the packet is constituted of a packet header section 1501 and a payload section 1504. The packet header section 1501 contains such data as the serial number of the packet, delivery time, and sender ID. The payload section 1504 is shown subdivided into an object metadata subsection 1502 and a padding data subsection 1503. The padding data is a dummy, usually consisting of a series of any required number of 0s, for filling up the margin left unoccupied by the object metadata and hence for making each packet constant in size. No padding data will be required if the object metadata occupies the complete payload section 1504.

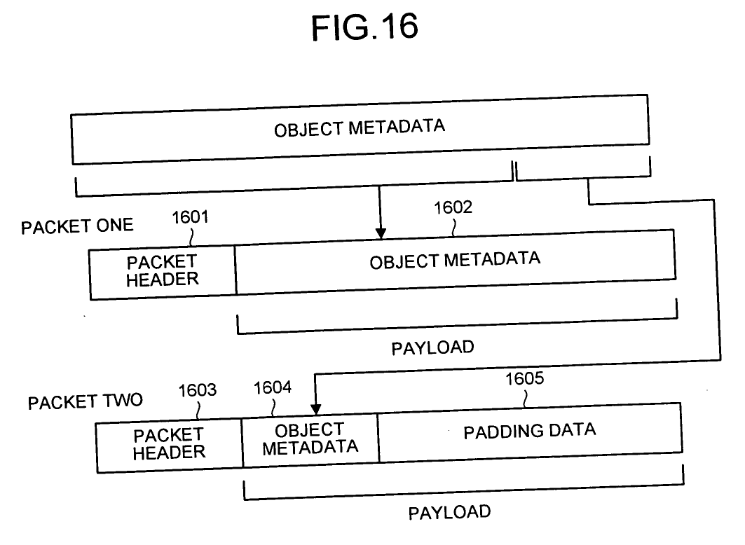

One series of object metadata may possibly be too large to be accommodated in one packet, in which case the maximum possible proportion of the metadata series may be loaded in one packet, and the balance in the next. FIG. 16 is explanatory of such divided loading of one series of object metadata in two consecutive packets. Packet One consists of a packet header section 1501 and an object metadata section 1602, the latter carrying the maximum possible part of the object metadata series and leaving no padding data section. The remainder of the object metadata series loaded on part 1604 of the payload section of Packet Two, and the rest 1605 of the payload section is filled up with padding data. One set of object metadata may be divided into three or more consecutive packets in a like fashion.

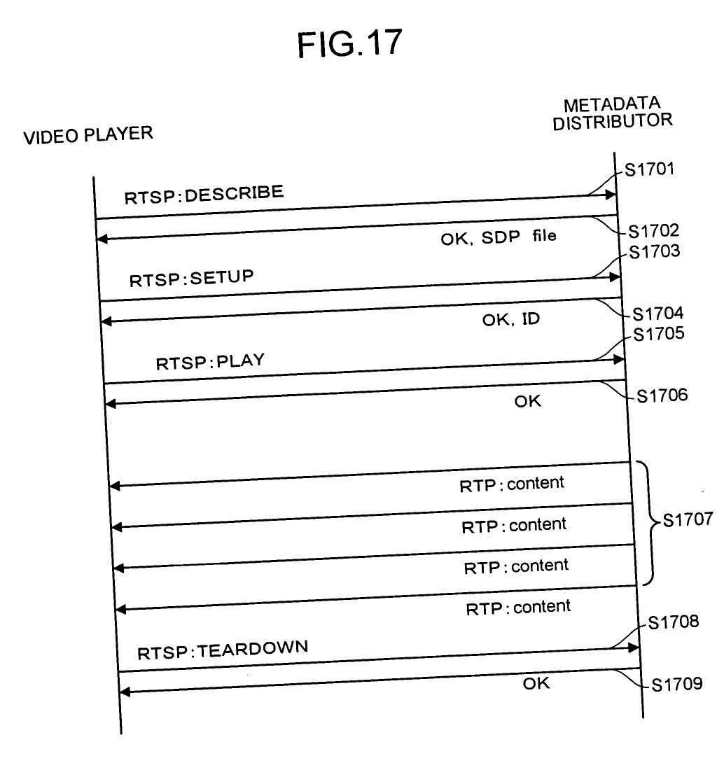

FIG. 17 is a sequential representation of intercommunications between video player 100 and metadata distributor 101 for each session of video reproduction. It is understood that Real-Time Streaming Protocol (RTSP) is used in this particular embodiment of the invention for two-way communication when the video player 100 demands metadata delivery from the metadata distributor 101, and Real-Time Transport Protocol for metadata delivery from metadata distributor to video player.

When the user of the video player 100 manipulates the input device 117 for playback of some chosen video program, this video player requests the metadata distributor 101 for information concerning the object metadata stream to be distributed therefrom, by the DESCRIBE method of RTSP (Step S1701). It is understood that the video player 100 has been informed of the IP address of the metadata distributor 101 for the delivery of the metadata corresponding to the video program to be played.

The metadata distributor 101 responds at Step S1702 to the information requests from the video player 100 supplies the information on object metadata in the form of a Session Description Protocol (SDP) file. The SDP file may include all such information as the session protocol version, session ownership, session name, connection information, session time information, metadata name, metadata properties, etc.

Then at Step S1703 the video player 100 requests the metadata distributor 101 for the setup of a session by the SETUP method of RTSP. In response to this request the metadata distributor 101 makes ready the streaming delivery of metadata and sends a session ID to the video player 100 at Step 1704. Then at Step S1705 the video player 100 requests the metadata distributor 101 for transmission of the object metadata by the PLAY method of RTSP. This request includes information indicative of the timestamp of the beginning of the video program. The metadata distributor 101 sends a confirmation message in response to the object metadata transmission request (Step S1706). Then, ascertaining where the object metadata stream starts to be delivered, the metadata distributor 101 actually commences the delivery of the object metadata in packet form to the video player 100 by RTP (Step S1707).

At Step 1708 is shown the video player 100 as sending a session termination request by the RTSP TEARDOWN method, as when the video reproduction by the video player 100 has come to an end or when object metadata delivery from the metadata distributor 101 is to be discontinued. The metadata distributor 101 responds to the session termination request by stopping data delivery, and so ending the session, and proceeds to send a confirmation message to the video player 100 (Step S1709). Thereupon the session ID that has been in use is invalidated.

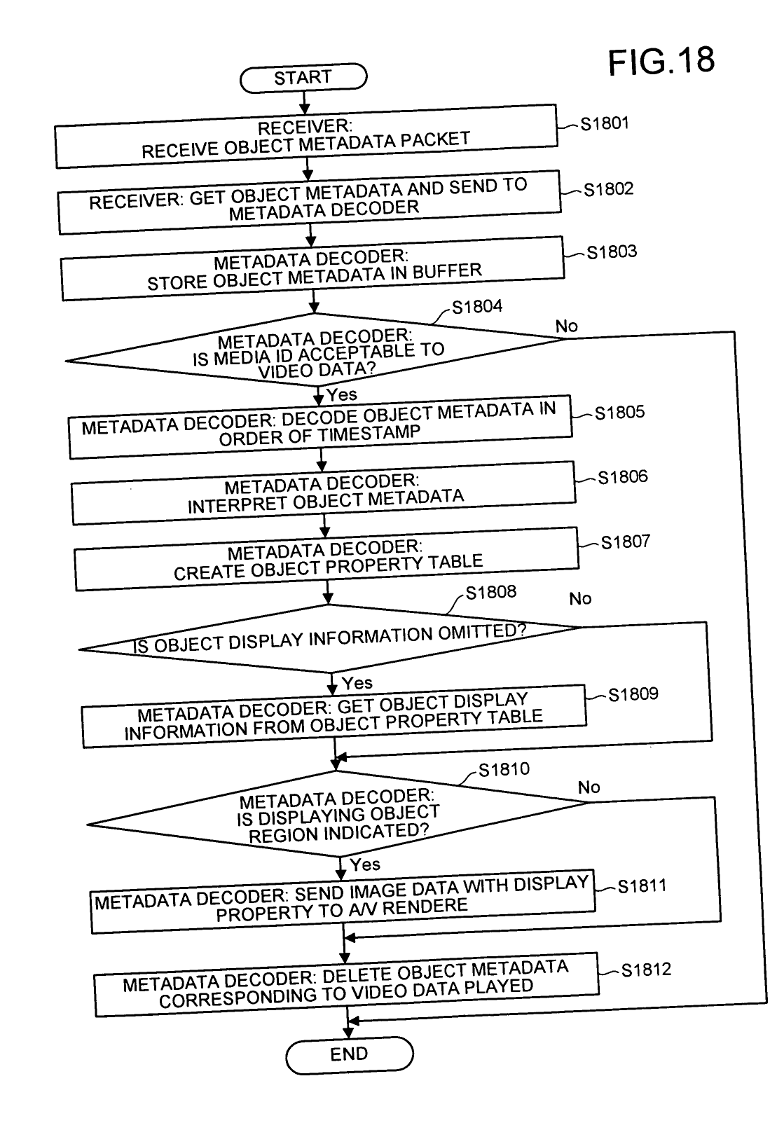

Receiving the metadata stream from the metadata distributor 101 as above, the video player 100 operates as dictated by the Metadata Decode Program which is preinstalled thereon and which is flowcharted in FIG. 18. The first block 1801 of this program indicates the receipt, by the receiver 109, FIG. 1, of the video player 100, of an object metadata packet from the metadata distributor 101. The receiver 109 derives the object metadata from the incoming packet and sends the same to the metadata decoder 110 at the block 1802. The metadata decoder 110 buffers the object metadata on a memory, not shown, at the block S1803.

Then comes a logical node S1804 where the metadata decoder 110 refers to the media ID on the ID subsection 601, FIG. 6, to ascertain whether or not the camera-angle and language settings conform to the video program to be played. If they do (answer “yes”), then at the next block S1805 the object metadata is decoded in the order of the timestamps. If the answer to the node S1804 is “no”, on the other hand, then the object metadata is not decoded, and the Metadata Decode Program is discontinued.

The controller 105, FIG. 1, of the video player 100 starts playing the video program when a predefined amount of data is buffered following the decoding of the object metadata at the block S1805. The timestamps of the video program being reproduced are successively directed into the metadata decoder 110. In synchronism with the thus-supplied timestamps the metadata decoder 110 decodes the object metadata at the block S1806 and, at the next block S1807, forms Object Property Tables listing correlations between the object metadata IDs and the object properties. Stored on the HDD, semiconductor memory or any such means, the Object Property Tables enable the video player 100 to make ready access to the object properties when object metadata units are received from which the object properties information (i.e. action script and object marking data) has been omitted either in whole or in part. The Object Property Tables include Action Script Table and Object Marking Information Table. The Action Script Table lists correlatons between action IDs on the ID subsection 602, FIG. 6, and the corresponding action scripts. The Object Marking Information Table lists correlations between marking information IDs on the ID subsection 603 and the corresponding object marking information. More will be said presently about the Object Property Tables.

Next comes another logical node S1808 which asks whether, for each incoming object metadata unit, the object marking information is omitted or not. The answer “yes” to this query leads to the block S1809, at which the required object marking information is ascertained by referring to one of the Object Property Tables. If the answer to the node S1808 is “no”, on the other hand, then the object marking information can be obtained directly from that object metadata unit.

Still another logical node S1810 is next encountered which asks the metadata decoder 110 whether the ascertained object marking information specifies some marking of the object or not. If it does, the next block S1811 dictates the production of the required marking image such as the masking or outlining of the object region. The object marking image is then sent to the audio/video renderer 112, FIG. 1, in step with the timestamps of the video program now being played. At the next, final block S1812 any obsolete object metadata, the metadata for the part of the video program that has been played, is deleted from the buffer.

The answer to the node S1810 may be “no”; that is, no marking method may be specified for the object region. No marking image need be formed in that case, so that the routine jumps to the final block S1812, bypassing the block S1811.

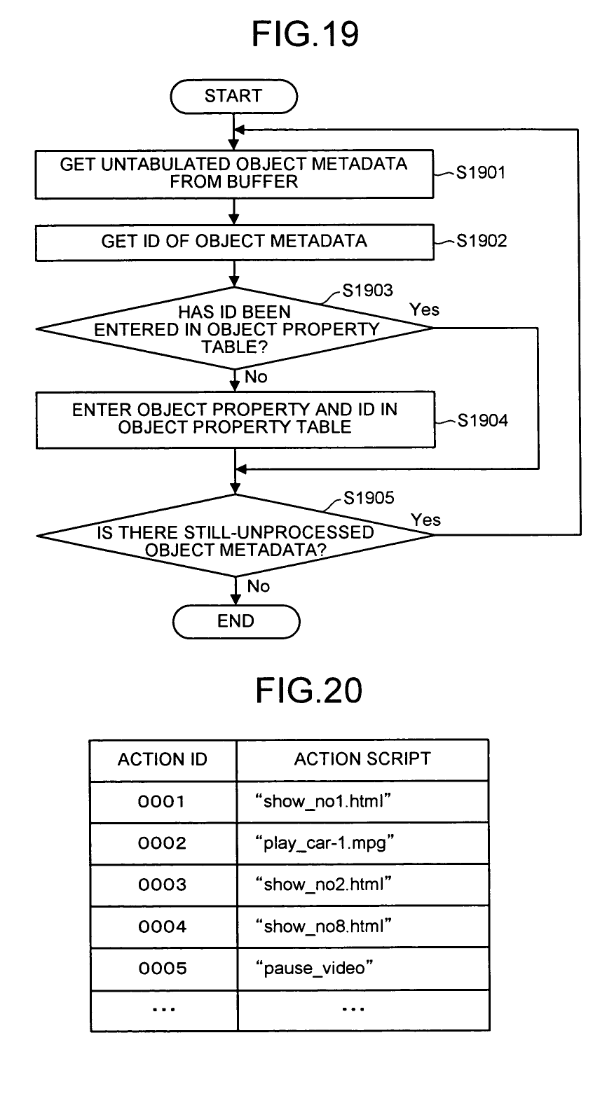

FIG. 19 is a flowchart of the subroutine to be executed at the block S1807 of the Object Metadata Decode Program, FIG. 18, for creating the Object Property Tables.

According to this subroutine the metadata decoder 110 obtains still-untabulated object metadata from the unshown buffer at the block S1901 and gets the IDs of such object metadata at the next block S1901. Then, at a logical node S1903, the metadata decoder 110 determines whether the successive IDs have already been registered on the preexisting Object Property Tables. If they are not, the metadata decoder 110 proceeds to enter the associated object properties and their IDs on the Object Property Tables at the block S1904. The object properties now under consideration are action script and object marking information, and the IDs are those associated with these properties. There are thus created the aforementioned Action Script Table, which lists correlations between action IDs and action scripts, and the Object Marking Information Table which lists correlations between object marking information IDs and object marking information.

Following the tabulation of the object properties and associated IDs at the block S1904, it is checked at another logical node S1905 whether the unshown buffer contains still-unprocessed object metadata or not. The cycle of the steps S1901-S1905 is repeated for all the object metadata buffered.

FIG. 20 shows an example of Action Script Table which has been formed as above explained with reference to FIG. 19. Action Script Table enumerates the action IDs and the filenames of the corresponding action scripts. This table is referred to for marking the objects and when the object regions are clicked by the viewer.

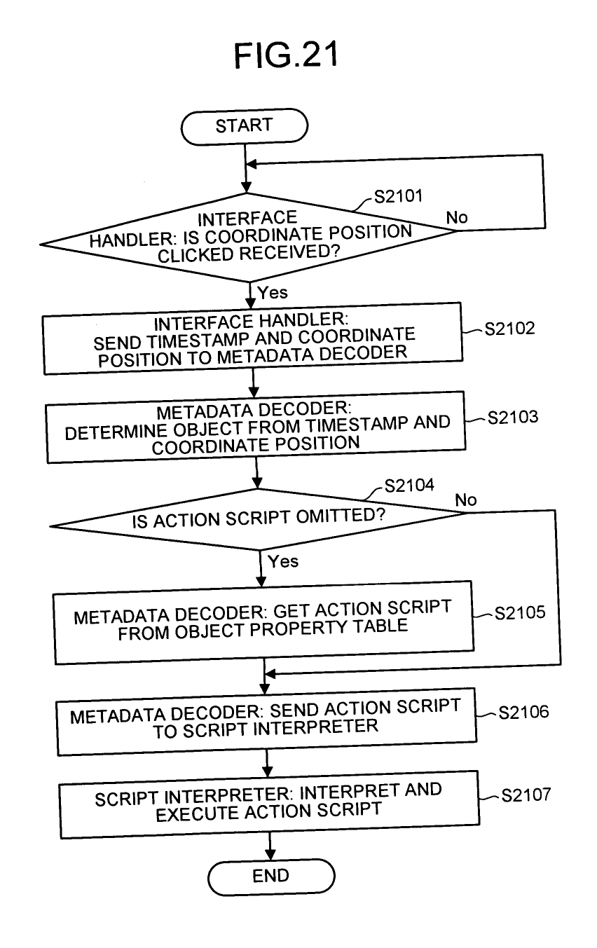

The flowchart given in FIG. 21 shows the program installed on the video player 100 to prescribe its operation when the hypermedia video viewer clicks on any object region on the display screen. At a logical node S2101 of this program the interface handler 107, FIG. 1, is awaiting the inputting of data representative of any coordinate position on the display screen where the viewer has clicked. The answer to this node will be “yes” when the viewer does click on some object region. Thereupon, at the next block S2102, the interface handler 107 will deliver to the metadata decoder 110 the coordinate position and the timestamp of the video program at the moment of the clicking.

At the next block S2103 the metadata decoder 110 responds by determining the object that has been specified by the viewer, on the bases of the incoming timestamp and coordinate position. Such determination will be easily accomplished since the metadata decoder 110 decodes the object metadata in step with the progress of video reproduction and knows the object regions at the timestamp when the object region is clicked. If two or more object regions overlap in the clicked position, it is assumed that the view has clicked upon the object that is positioned most in the foreground of the scene. Toward this end the metadata decoder 110 may refer to the hierarchy information on the subsection 500, FIG. 5, of the object property information section 402, FIG. 4, of each object metadata unit. As has been stated with reference to these figures, the hierarchy information determines the hierarchical rank of each object in cases where a plurality of object regions overlap one upon another on the display screen: The smaller in value the hierarchy data, the more is the object positioned in the foreground of the scene.

The object that has been presumably selected by the viewer having been specified as above, the metadata decoder 110 proceeds to check, at another logical node S2104, if the action script 501, FIG. 5, of the object property information is omitted from the object metadata. If it is (answer “yes” to the node S2104), then at the next block S2105 the metadata decoder 110 obtains the action script 501 corresponding to the action ID of the object metadata. Then, according to the next block S2106, the metadata decoder 110 delivers the obtained action script to the script interpreter 111 via the interface handler 107. This action script delivery to the script interpreter 111 will not occur if the Object Property Tables have not yet been formed by reasons such as packet dropouts, the action scripts being then unascertainable.

Upon receipt of the action script 501 the script interpreter 111 interprets and executes the same at the final block S2107. Thus, for example, the video player may either exhibit an HTML file specified or display some video program, resulting in realization of hypermedia. The HTML files or video programs to be specified by the action script 501 may be either prerecorded on the video player 100 or delivered over the Internet or like computer network.

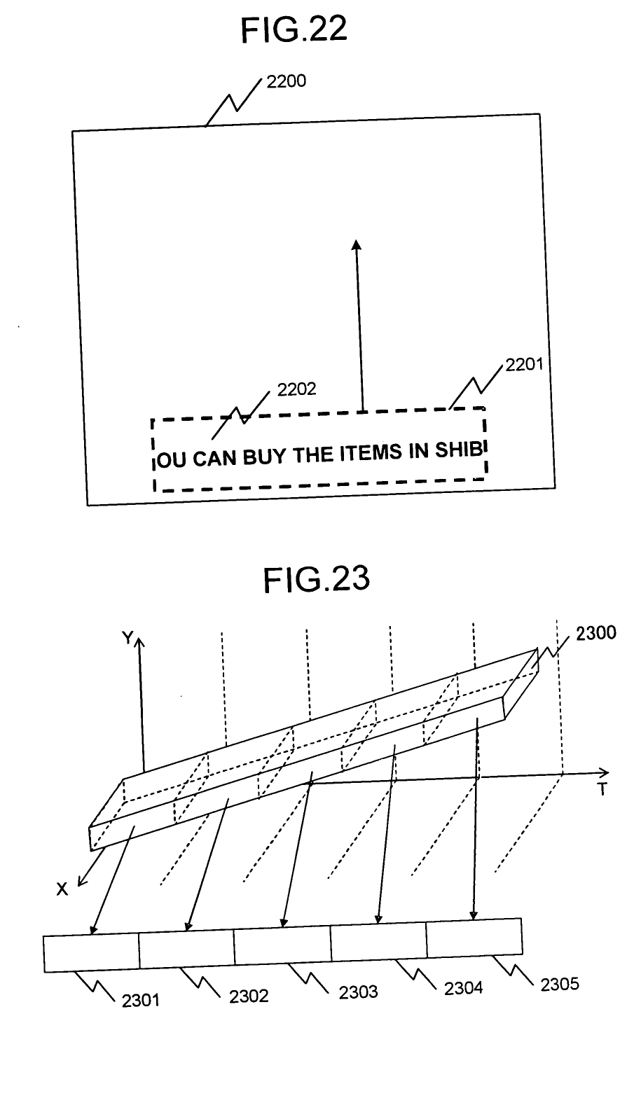

Telop exhibition is also possible in synchronism with the reproduction of a video program as a kind of object marking according to the object marking information. FIG. 22 is explanatory of how a telop is exhibited on a display screen 2200 of the video player 100. The display screen 2200 has a telop zone 2201 in which is exhibited a telop 2202 in the form of a succession of characters or words. The telop 2202 may be either still or mobile, traveling leftward to reveal additional characters or words, and some of these may be highlighted to draw attention. Further, as in the case of karaoke words display, the characters or words may be successively changed in color or made to blink in step with the progress of the song. Still further, as indicated by the arrow in FIG. 22, the telop zone 2201 together with the telop 2202 therein may be made to travel upwardly of the display screen with the lapse of time. This subject is elaborated hereinbelow.

FIG. 23 plots a continuum 2300 of such displaceable telop zone 2201 in the time space defined by horizontal axis X, vertical axis Y, and video program time axis T, just as the object region 300 is plotted in FIG. 3. The traveling telop zone continuum 2300 is represented by object region data at prescribed time intervals of, say, from 0.5 to 1.0 second. In FIG. 23, for example, the telop zone continuum 2300 is shown divided into five segments represented respectively by as many units of object region data 2301-2305. The telop zone 2201 may not necessary travel upward at constant speed. Variable speed displacement is also possible according to object region data prepared by the known MPEG4 shape coding method, MPEG-7 time-space descriptor method, and so forth.

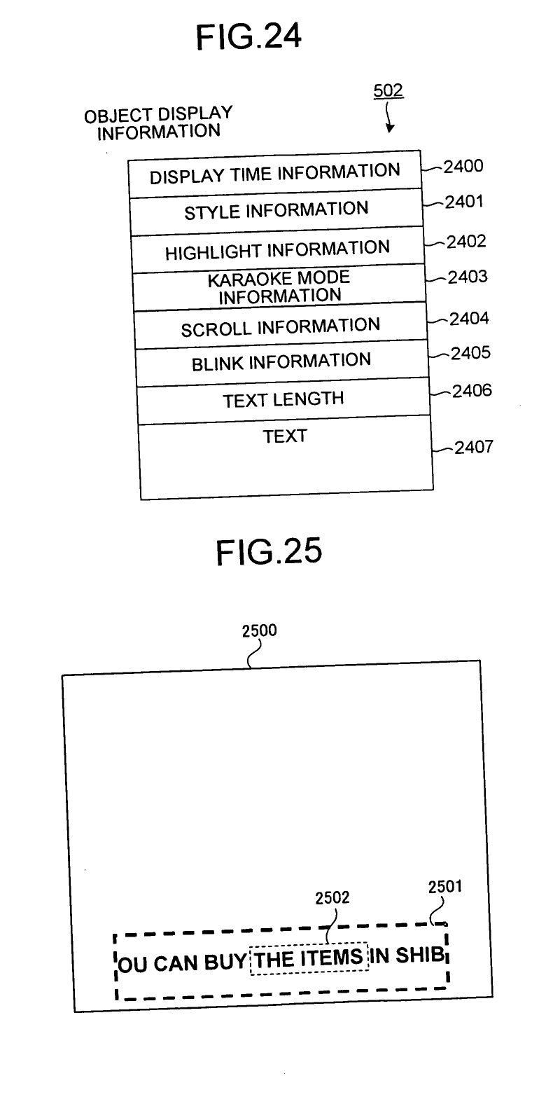

FIG. 24 is a representation of the configuration of the object marking information included in the object metadata for an upwardly traveling telop. The object marking information is herein shown to comprise display time information 2400, style information 2401, highlight information 2402, karaoke mode information 2403, scroll information 2404, blink information 2405, text length 2406, and text 2407. All such information will be explained subsequently in some more detail. Depending upon how the telop is presented on the display screen, however, either or all of the highlight information 2402, karaoke mode information 2403, scroll information 2404, and blink information 2405 may be omitted. Some other information may also be added as required for telop presentation in some different fashion.

The display time information 2400 represents the beginning and ending moments of telop display, or the beginning moment and length of telop display. This display time information will be unnecessary if the beginning and end of telop display agree with the beginning and end of the associated object region appearing on the display screen.

The style information 2401 specifies the font, and its size, of the text to be exhibited. The highlight information 2402 indicates those of the telop characters or words which are to be highlighted. The karaoke mode information 2403 dictates the timing of color change from the beginning toward the end of the characters or words exhibited; for example, it may specify three seconds for color change from the first to the tenth characters, two seconds from the eleventh to the twenty-fourth characters, and so forth. The scroll information 2404 indicates the speed and direction of text scroll through the telop zone. The blink information 2405 specifies the words or characters to be blinked as well as the frequency of the blinking. The text length 2406 indicates the number of words or characters to be exhibited on the telop zone. The text 2407 indicates the characters or words to be actually exhibited on the telop zone by the number specified by the text length 2406.

Use of the object metadata including the object marking information of FIG. 24 makes it possible to exhibit a telop that travels upwardly with the progress of video reproduction. Further, using the action script on the subsection 501, FIG. 5, of the object property information section 402, FIG. 4, of each object metadata unit, either an HTML file may be displayed, or a video program played, as dictated by the action script when the view clicks on the telop zone. What follows is a description of an example of such video player action in response to the clicking of some words or characters of the telop being exhibited on the display screen.

Let it be assumed that, as drawn in FIG. 25, a telop is being exhibited on a telop zone 2501 of a display screen 2500, and that the viewer has just clicked on some word or words, or character or characters, such as those indicated at 2502. The telop scrolls leftward according to the scroll information 2404, FIG. 24, so that the group of words 2502 appears at the right-hand end of the telop zone 2501, travels leftward, and disappears at its left-hand end. It may be noted that the telop zone 2501 and the words 2502 of the telop text make up different objects which, therefore, are expressed by different sets of object metadata.

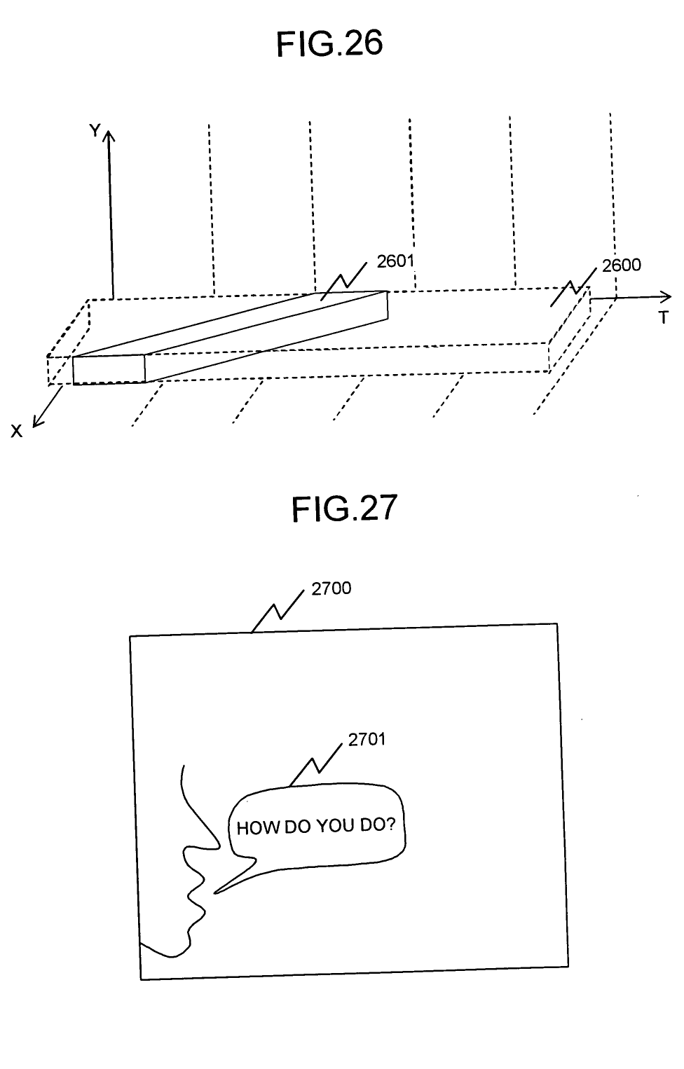

FIG. 26 is a diagram similar to FIGS. 3 and 23 but showing zones associated with the telop display of FIG. 25. The zone 2600 in this figure corresponds to the telop zone 2501, FIG. 25, and the zone 2601 to the group of words 2502. For exhibiting the telop as in FIG. 25, the object region data for the zone 2600 is included in the object metadata, and the action script of the object property information defines the action to be taken when the telop zone 2501 is clicked. On the other hand, the object metadata including the object region data for the zone 2601 contains script specifying the action to be taken upon clicking of the word group 2502 within the telop zone 2501. As regards the hierarchy information for the zones 2600 and 2601, the telop zone 2501 may be made lower in rank than the word group zone 2502, in order that the action script for the latter may be implemented preferentially upon clicking of the word group.

A further example of object marking is the outlining of text on the display screen in the course of video reproduction by the video player 100, as pictured in FIG. 27. In this figure the text (i.e. the words spoken by the person portrayed) on the display screen 2700 is shown encircled in an outline 2701, much like a comicbook balloon. The viewer will then be able to readily discern which object the outlined text or other information is associated with.

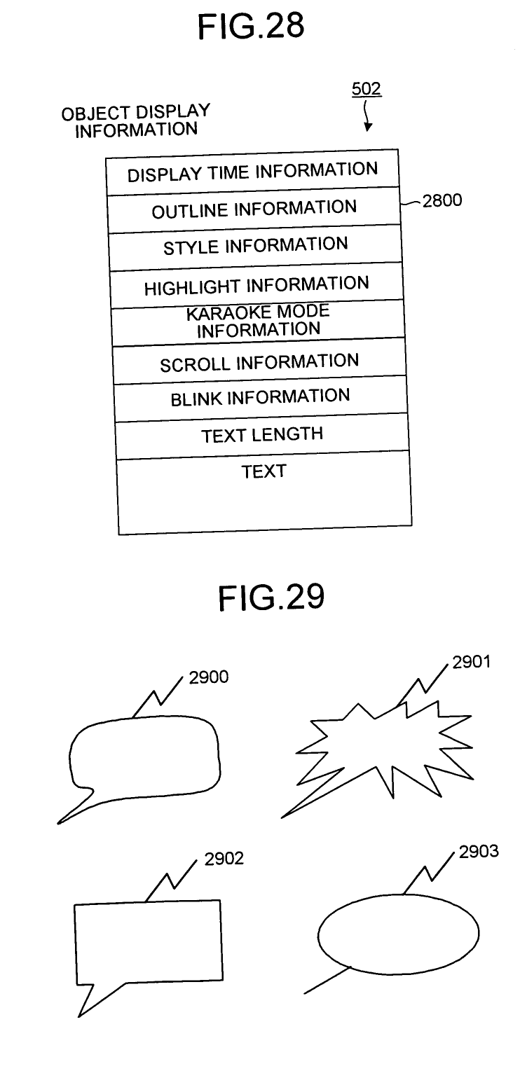

FIG. 28 is explanatory of the configuration of object marking information for the outlined text display of FIG. 27. The object marking information configuration here is akin to that of FIG. 24 for telops except that the former includes outline information 2800 in addition to all the information 2400-2407 shown in FIG. 24. The outline information 2800 include preassigned outline numbers, which represent predefined outlines to be displayed, or their bitmaps. For example, as depicted in FIG. 29, an appropriate number (e.g. four) of different outlines 2900-2903 may be predefined, and numbers 1-4 assigned to the respective outlines. Not only the desired kind of outline but also the thickness and color of the outline, and the color and permeability of the area inside the outline may be rendered specifiable as required or desired. Bitmaps may be added to the outline information 2800 for exhibition of outlines other than the predefined ones.

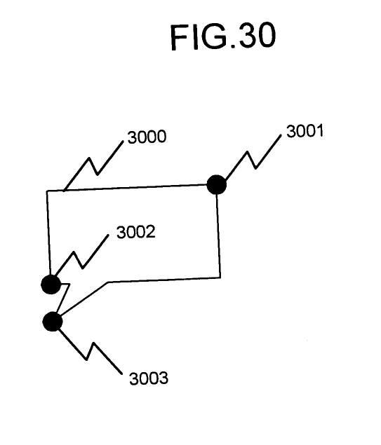

In order to determine the size and position of the outline to be exhibited, the coordinate positions of some preselected points of each outline may be set forth as part of the object region data. In FIG. 30, for example, three representative points 3001-3003 are predetermined on the outline 3000 to be displayed. The three representative points 3001-3003 are so chosen that the substantially rectangular part of this outline 300 is expansible or reducible by the placement of the two points 3001 and 3002 relative to each other. The protuberance of the outline 300 is definable by the positioning of the third point 3003. The positions of the representative points 3001-3003 are currently believed to be definable most efficiently by the time-space descriptors of MPEG-7.

Thus the present invention succeeds in the provision of hypermedia with the delivery of metadata, from which object property information is omitted wherever possible, from metadata distributor 101 to video player 100. In delivering metadata from metadata distributor 101 to video player 100, for each object metadata unit that is to bear the same action script as the other units, the same action ID is given to the object metadata unit as that of the other units, and the action script is omitted. Similarly, for each object metadata that is to bear the same object marking information as the other units, the same marking information ID 603, FIG. 8, is assigned to the object metadata unit as that of the other units, and object marking information itself is omitted. A significant diminution is thus accomplished in the amount of metadata supplied from metadata distributor 101 to video player 100, conducing to the realization of more efficient hypermedia.

According to the further features of the invention, upon receipt of the metadata, there are created in the video player 100 both Action Script Table, which lists correlations between action IDs and action scripts, and Object Marking Information Table which lists correlations between object marking information IDs and object marking information. For all the object metadata units from which action script or object marking information has been omitted, the missing action script or object marking information is retrieved from these object property tables. Accurate display of object information is therefore possible from the received metadata despite the omission of some object property information therefrom during its delivery from the object distributor.

In the first preferred embodiment set forth hereinbefore with reference to FIGS. 1-30, the missing object property information was retrieved when object marking is required and when an object region is clicked. By contrast, in this alternate embodiment, the incomplete object metadata units are all reconstructed by the video player upon receipt thereof from the metadata distributor.

Both video player and metadata distributor can be the same in terms of hardware as those shown at 100 and 101 in FIG. 1. Metadata to be handled can also be of the same configuration as that of the preceding embodiment Functionally, however, the metadata decoder 110, FIG. 1, for use in this alternate embodiment differs from that used in the preceding embodiment in not creating the object property tables upon receipt of object metadata from which the object property information has been omitted either partly or wholly.

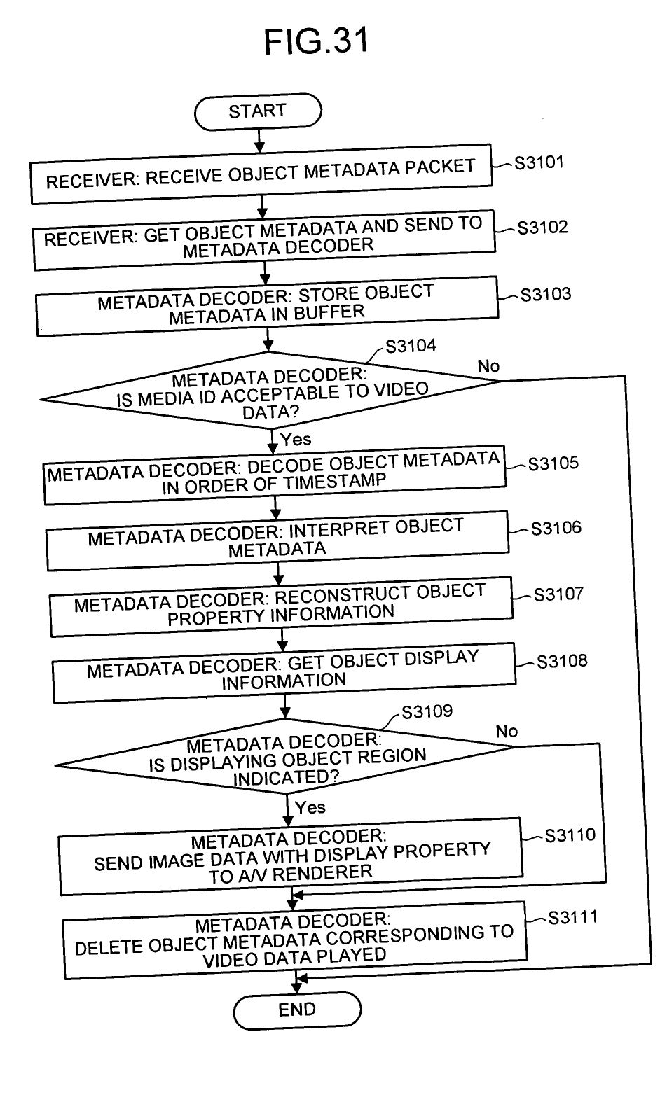

FIG. 31 is a flowchart of Metadata Decode Program which is similar to that of FIG. 18 but which is modified according to the teachings of this alternate embodiment. The steps S3101-S3106 of the modified Metadata Decode Program, specifying operations from metadata packet reception to metadata decoding, are the same as the corresponding steps S1801-1806 of the FIG. 18 program. No repeated explanation of these duplicate steps is deemed necessary.

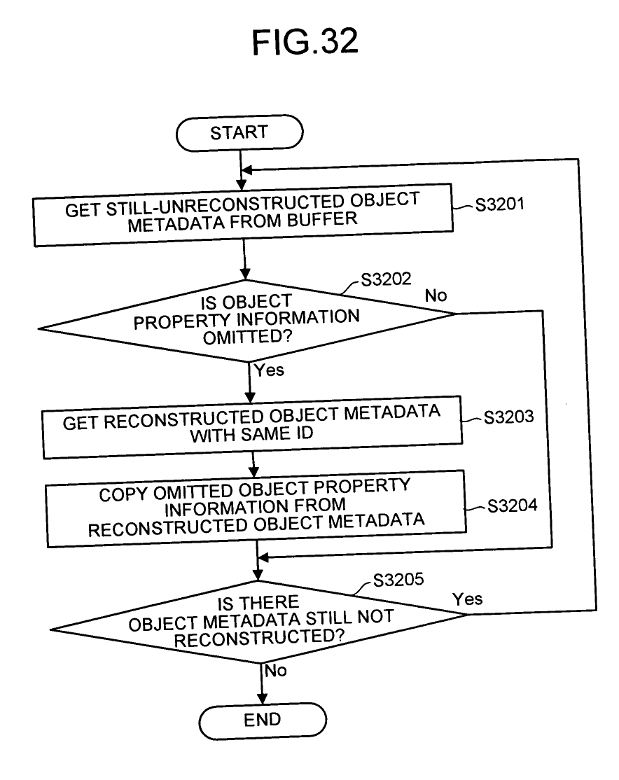

At the block S3107 of the modified Metadata Decode Program the metadata decoder 110 reconstructs the decoded object metadata, filling up the omissions by the subroutine given in FIG. 32, to which reference will be had presently. Then at the next block S3108 the metadata decoder 110 obtains object marking information from the object property information and ascertains at a logical node S3109 if the obtained object marking information specifies the making of the object region. If the answer to the node S3109 is “yes”, then at the next block S3110 an image specified by the object marking property (e.g. masking or outlining of the object region) is generated and sent to the audio/video renderer 112, FIG. 1, in step with the timestamps of the video program being played. At the next, final block S3111 the used object metadata (i.e. the metadata for the part of the video program that has been played) is deleted from the buffer.

The answer to the node S3109 may be “no”; that is, no marking of the object region may be specified. No marking image need be formed in this case, so that the routine jumps to the final block S3111, bypassing the block S3110.

Reference is now invited to the flowchart of FIG. 32 which shows the subroutine of the Object Metadata Decode Program, FIG. 31, to be executed at the block S3107. This subroutine is designed as aforesaid for reconstruction of those object metadata units from which some object property information has been omitted. The metadata decoder first obtains still-unprocessed object metadata from the unshown buffer at the block S3201 and proceeds to determine at a logical node S3202 if the object metadata has omissions in object property information. The object property information may have been omitted either in part or in whole.

The answer “yes” to the node S3202 directs the subroutine to the block S3203, where the previously reconstructed object metadata of the same ID is obtained. That is, if action script has been omitted, the previously reconstructed object metadata of the same action ID is obtained, and if object marking information has been omitted, the previously reconstructed object metadata of the same making information ID 603, FIG. 8, is obtained. The required object property information is then copied from the previously reconstructed object metadata to the object metadata now being reconstructed, at the block S3204. Here again, if action script has been omitted, action script is copied from the previously reconstructed object metadata of the same action ID, and if object marking information has been omitted, object marking information is copied from the previously reconstructed object metadata of the same marking information ID 603.

Following the block S3204, another logical node S3205 requires, in short, that the steps S3201-S3204 be performed for all the object metadata that need reconstruction. The required object property information will thus be added to all the object metadata.

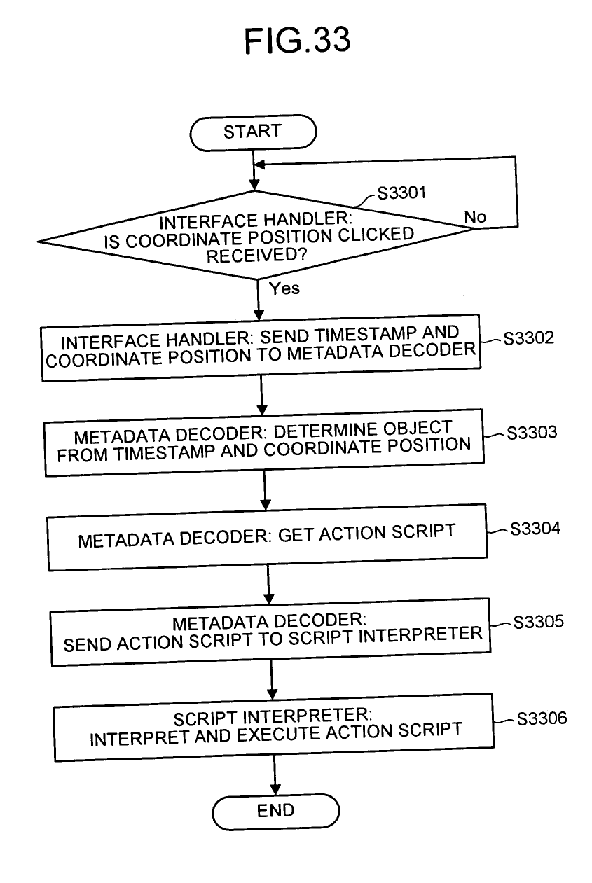

FIG. 33 is a flowchart of another program built into the video player 100 to dictate the steps to be followed when the viewer clicks on an object region. A similar program in the first disclosed embodiment of the invention is flowcharted in FIG. 21. A comparison of FIGS. 21 and 33 will reveal that both programs are alike in the first three steps (S2101-S2103 and S3301-S3303), that is, from the receipt of input data indicative of a particular coordinate position on the display screen to the determination of the object clicked by the viewer. No repeated description of the steps S3301-S3303 of the FIG. 33 program will therefore be necessary.

At the next block S3304 the metadata decoder 110, FIG. 1, obtains the action script 501, FIG. 11, from the object property information of the object clicked, and proceeds at the block S3305 to send the action script to the script interpreter 111. It is understood that those object metadata units from which object property information has been omitted at the time of their delivery to the video player have all regained their proper object property information by virtue of the reconstruction program above. The script interpreter 111 interprets and executes the incoming action script 501 at the block S3306, as by displaying an HTML file specified or by playing back a video program specified.

Thus, as in the first describe embodiment of the invention, video-oriented hypermedia is realized with a substantial reduction in the amount of metadata delivered to each client video player. Those object metadata units from which the object property information has been omitted can be accurately reconstructed by the video player for display of any associated information upon clicking of each object. Upon receipt of a packet or packets of metadata including incomplete units, which lack in some object property information such as action script or object marking information, the video player reconstructs the received metadata altogether. This feature of the alternate embodiment is conducive to the swift, accurate exhibition of desired additional information in response to the clicking of an object.

A further reduction of the amount of metadata distributed to each client is accomplished by omitting object region data, in addition to the omission of part or all of the object property information as in the foregoing two embodiments, wherever such omission is possible. Omission of object region data is possible, however, only in cases where the object region represented is immobile. This third embodiment also presupposes use of the client/server architecture such as that of FIG. 1. The hardware of the video player 100 and metadata distributor 101 can be the same as that shown in FIG. 1.

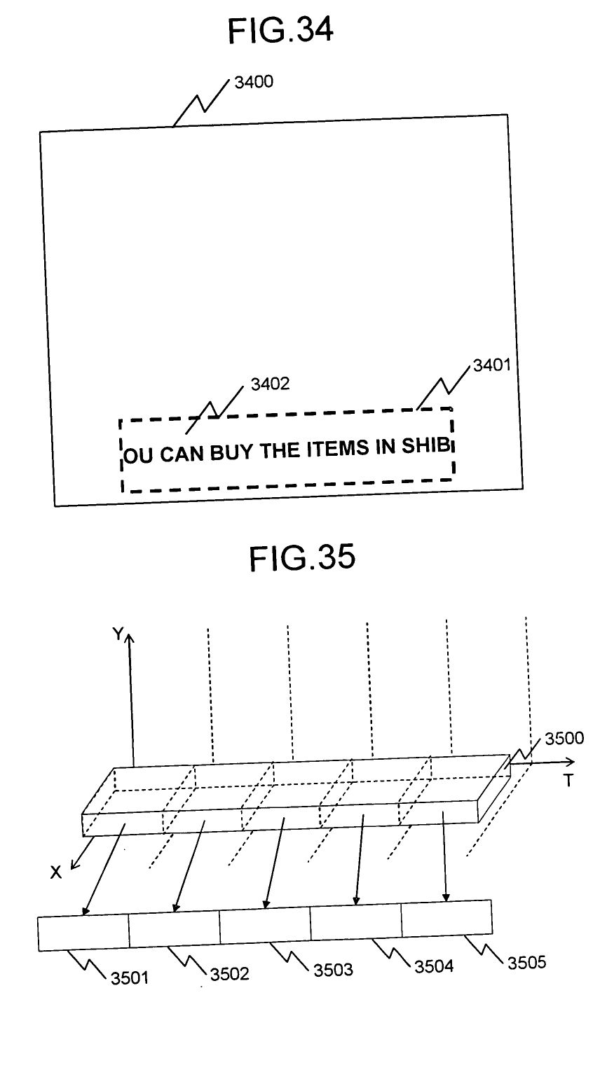

A typical example of object region permitting omission of object region data according to the teachings of this embodiment is a fixed telop zone seen at 3401 in FIG. 34. Unlike the mobile telop zone 2201 of FIG. 22, which travels upwardly of the display screen 2200 with the lapse of time, the telop zone 3401 is fixed in the illustrated position on the display screen 3400. However, the telop 3402 exhibited in this fixed telop zone 3401 may itself be either fixed or scrolled, traveling leftward to reveal additional characters or words, and some of the characters or words may be highlighted. It is also possible that, as in the case of karaoke words display, the characters or words may be both scrolled and successively changed in color or made to blink in step with the progress of the song.

In FIG. 35 is plotted a continuum 3500 of the fixed telop zone 3401 in the time space defined by horizontal axis X, vertical axis Y, and video program time axis T, just as the mobile telop zone 2300 is plotted in FIG. 23. During the period of time given in this diagram the fixed telop zone continuum 3500 is shown divided into five segments, and these segments are represented respectively by as many sets or units of object region data 3501-3505.

It will be observed that no change in the position of the telop zone occurs in the plane defined by the axes X and Y, the telop zone itself being assumed to be fixed on the display screen. Consequently, only if the fixed position of the telop zone is fully described in the first object region data unit 3501, the succeeding units 3502-3505 will be unnecessary, these being capable of restoration later in the video player by replication of the first unit.

Thus, in this embodiment of the invention, the object region data indicative of the fixed telop zone is stored only in the first of the series of object metadata units and omitted from the rest Such omission of object region data is possible not only with the fixed telop zone but further with any other object whose position on the display screen does not change with time. Additional curtailment is thus accomplished in the amounts of data that must be transmitted from metadata distributor 101 to video player 100.

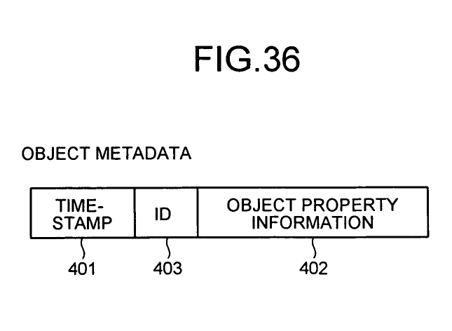

FIG. 36 is explanatory of data configuration in each unit of object metadata from which object region data has been omitted. The modified object metadata unit is constituted of the timestamp section 401, ID section 403, and object property information section 402, but has no object region data section such as that shown at 400 in FIG. 4. It is understood that the object property information section 402 includes object marking information of the same data configuration as that indicated in FIG. 24. As has been set forth in conjunction with the foregoing embodiments, the object property information on the section 402 may also be omitted, either partly or wholly, as long as such information is unchanged.

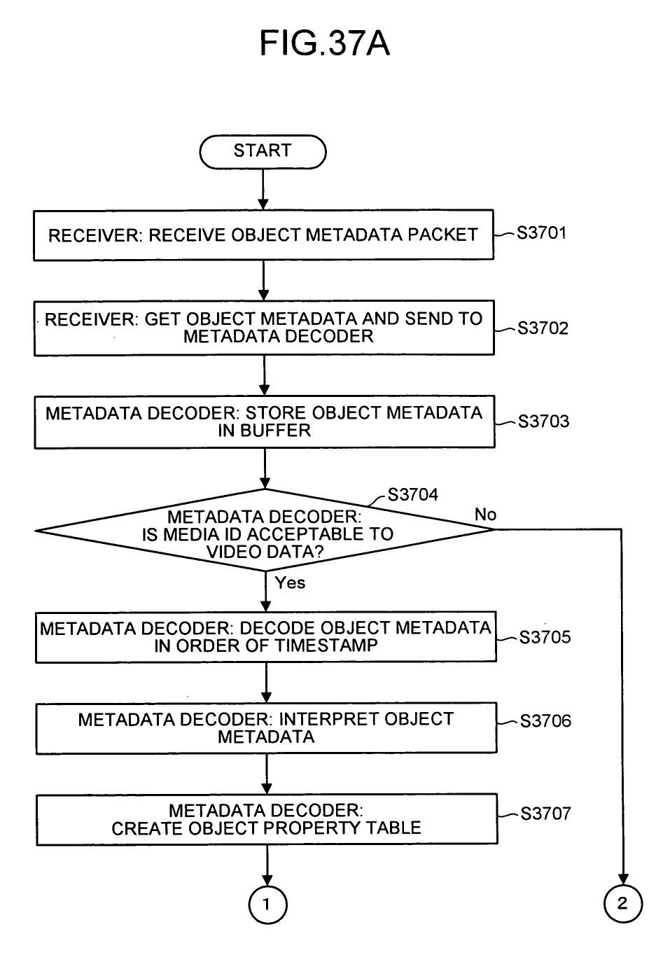

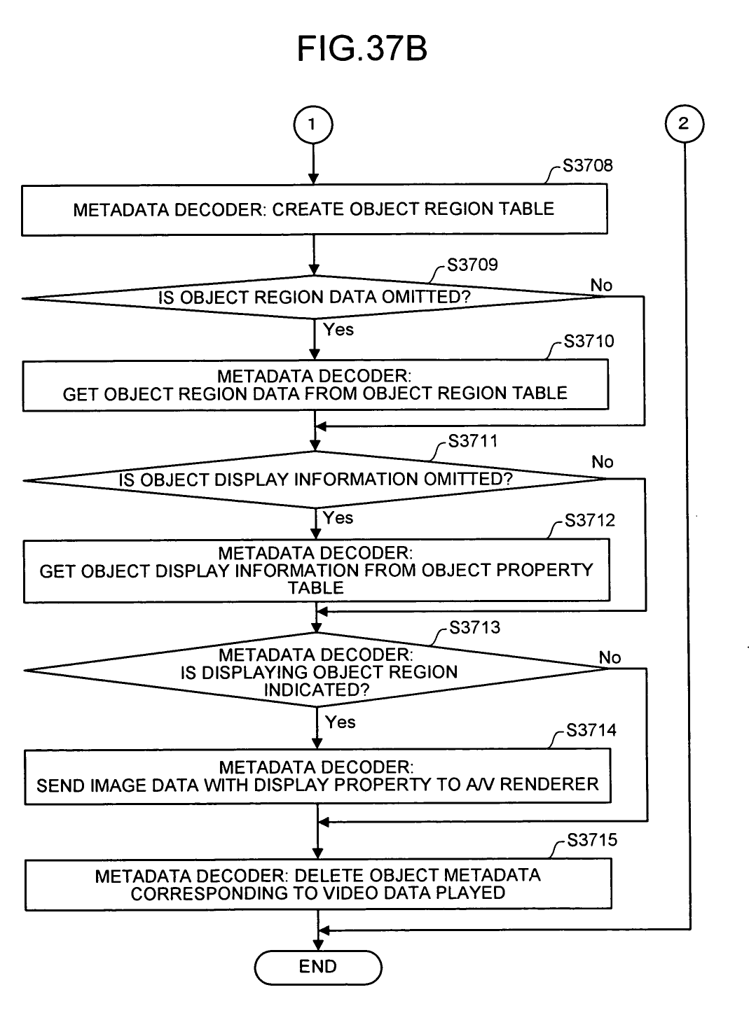

Receiving from the metadata distributor 101 the metadata stream from which object region data has been omitted wherever possible as above, the video player 100 is to operate according to the Metadata Decode Program flowcharted in both FIGS. 37A and 37B. A comparison of FIG. 37A with FIG. 18 will show that the first seven steps S3701-S3707 of this program, from the receipt of an object metadata packet from the metadata distributor 101 to the creation of the Object Property Tables by the metadata decoder, are identical with the corresponding steps S1801-S1807 of the program of FIG. 18. These duplicate steps S3701-S3707 are therefore considered self-explanatory.

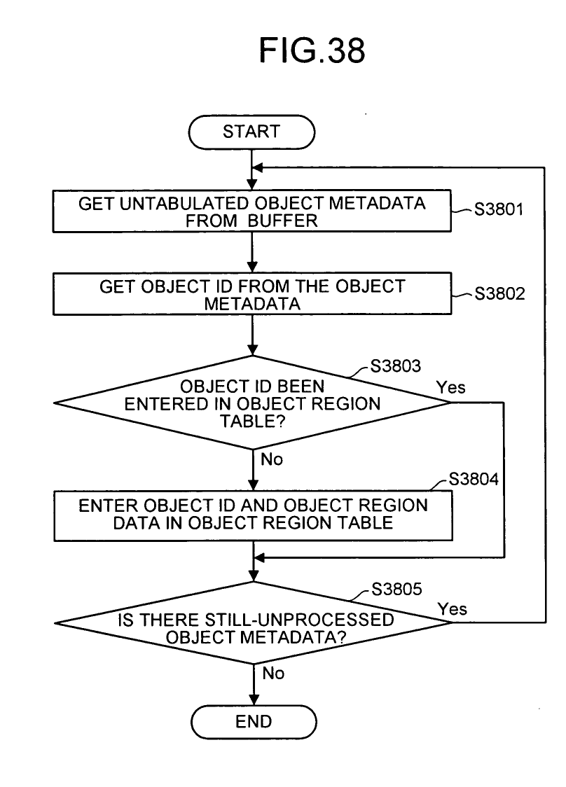

A block S3708, FIG. 37B, is next encountered where the metadata decoder 110 creates Object region Table. Stored on the HDD, memory, or like storage means, the Object region Table is to be referred to when an object metadata packet is received from which object region data has been omitted. The Object region Table is a list of object IDs and object region data and is to be formed according to the subroutine flowcharted in FIG. 38, to which reference will be had shortly.

Next comes a logical node S3709 which asks whether, for each incoming object metadata unit, object region data is omitted or not. The answer “yes” to this query directs the program to the block S3710, at which the Object region Table is referred to ascertain the required object region data from the object ID in question. If the answer to the node S3709 is “no”, on the other hand, then the object region data is obtained directly from that object metadata unit, and the block S3710 is bypassed. The subsequent steps of operation, from logical node S3711 to block S3715, are akin to the corresponding steps S1808-S1812 of the Metadata Decode Program of FIG. 18.

FIG. 38 is a flowchart of the aforesaid subroutine to be executed at the block S3708 of the Object Metadata Decode Program, FIGS. 37A and 37B, for creation of the Object region Table. According to this subroutine the metadata decoder 110 obtains still-untabulated object metadata from the unshown buffer at the block S3801 and obtains the IDs of such object metadata at the next block S3802. Then, at a logical node S3803, the metadata decoder 110 determines whether the successive IDs have already been registered on the preexisting Object region Table. If they are not, the metadata decoder 110 proceeds to enter the associated object region data and IDs on the Object region Table at the block S3804.

Following the tabulation of the object region data and associated IDs at the block S1904, it is checked at another logical node S3805 whether the unshown buffer contains still-unprocessed object metadata or not. The cycle of the steps S3801-S3804 is repeated for all the object metadata which is buffered.

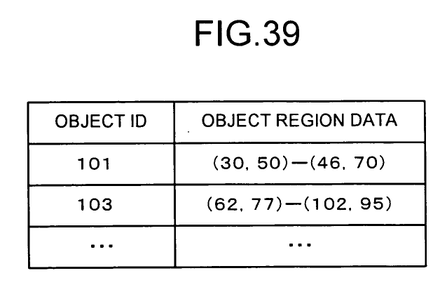

FIG. 39 is an illustration of an example of the Object region Table which has been formed as above explained with reference to FIG. 19. It will be observed from this figure that the Object region Table is an enumeration of object IDs and the corresponding object region data.

The teachings of this third embodiment of the invention are applicable to each series of object metadata units bearing the same object region data, that is, the object region data representative of a fixed telop or like object region set forth with reference to FIGS. 34 and 35. The same object ID is assigned to all such units, and the object region data is omitted from all but one of them for most efficient object metadata delivery from metadata distributor 101 to video player 100. Furthermore, inputting the object metadata stream, the video player 100 creates the Object region Table, FIG. 39, as dictated by the Metadata Decode Program of FIGS. 37A and 37B correlating the object IDs and the object region data. This Object region Table is referred to for all the object metadata units from which the object region data has been omitted, in order to recover the missing object region data. Thus is the video player 100 enabled to accurately reconstruct the object metadata despite the omission, wherever possible, of the object region data therefrom, so that the hypermedia features of the video program are in no way impaired by such omission.

The preparation of the Object region Table is, however, not an essential feature of the present invention; instead, the object metadata units from which object region data has been omitted may first be reconstructed as in the embodiment of FIGS. 31-33. Such reconstruction of the object metadata without relying upon the Object region Table will lead to the easier, more efficient processing of both metadata and video data and hence to the effective realization of hypermedia from intrinsically non-hypermedia disks.

Contrary to the teachings of all the foregoing embodiments of the invention, it is not an absolute requirement that metadata be stored on the metadata distributor 101 and delivered to the video player 100. A possible alteration of this metadata delivery system, apparent to the specialists of the Internet and allied arts, is to store metadata on the video player 100 itself, for use whenever an associated video program is played.

This embodiment of the invention represents a total departure from the client/server architecture of FIG. 1 and finds application to the Enhanced DVD. Prerecorded on this video disk are both video program and object metadata according to the present invention, in addition to various other standard computer data, as hereinafter explained in more detail.

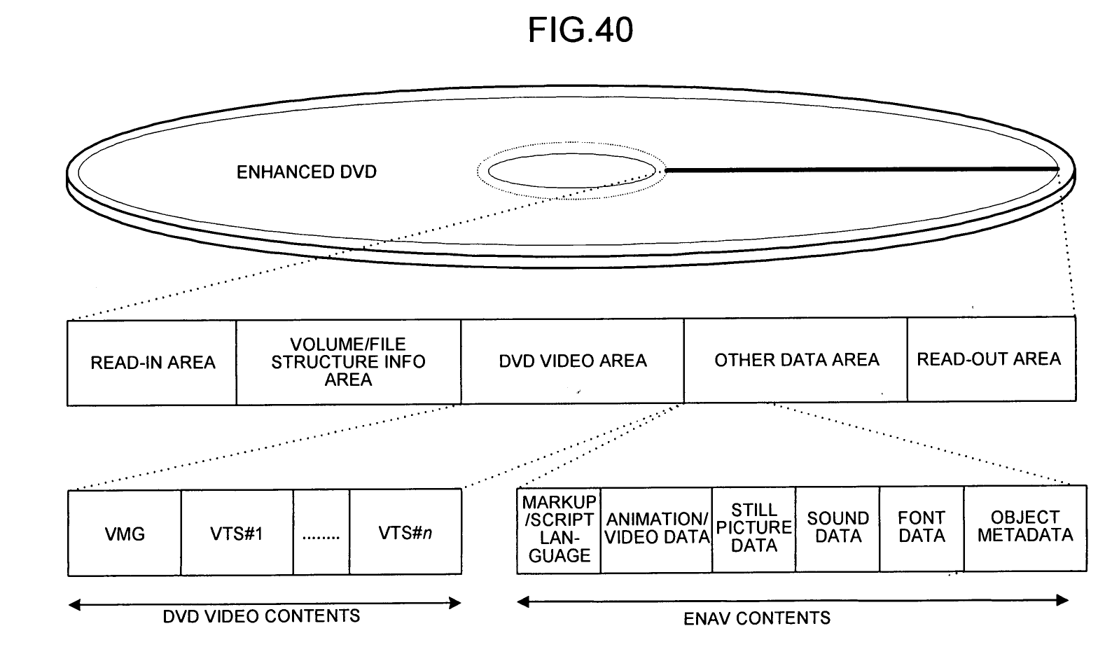

FIG. 40 is explanatory of data configuration on the Enhanced DVD as adapted to bear object metadata according to the invention. The Enhanced DVD has a recording area comprised of, from the radially inmost end outward, a read-in area, a volume/file structure information area, a DVD video area, an other data area, and a read-out area. The volume/file structure information area, DVD video area, and other data area are, in combination, sometimes referred to as volume space. The DVD video area has stored thereon a DVD video program which has the MPEG-2 program stream structure and which has data configuration in conformity with the DVD video standards. The other data area of the Enhanced DVD stores what is known in the art as enhanced navigation (ENAV) contents designed to give greater diversity and versatility to the video program. The object metadata according to the instant invention is shown recorded on the Enhanced DVD as part of the ENAV data in this particular embodiment of the invention.

The volume/file structure information area is assigned to the universal disk format (UDF) bridge structure. The UDF bridge volume is recognized according to Part Two of ISO/IEC 13346. The space for such volume recognition consists of a consecutive sector, starting from the first logic sector of the volume space. The first hexadecimal logic sector is reserved for use of the system specified in ISO 9660 by International Organization for Standardization. Such volume/file structure information area is needed to assure compatibility with the conventional DVD video standards.

The DVD video area has prerecorded thereon management information known as Video Manager (VMG) and one or more video title sets (VTS#1-VTS#n). The VMG covers all the VTS existing in the DVD video area and includes Video Manager Information (VMGI), optional video object set for VMG menu (VMGM_VOBS), and VMG backup. Each VTS includes VTS information (VTSI), optional video object set for VTS menu (VTSM_VOBS), video object set for titles (e.g. motion pictures) in a VTS (VTSTT_VOBS), and VTSI backup. The DVD video area of such content is also needed for compatibility with the conventional DVD video standards.

The menu for selective playback of the prerecorded titles (VTS#1-VTS#n) and similar features are prescribed by the provider (manufacturer of the DVD in this case) in the VMG The menu for selective playback of chapters in each title (e.g. VTS#1) and the procedure of cell playback are also predefined by the provider in the VTSI. The DVD user has therefore been conventionally able to enjoy the recordings on the disk according to the menu of the VMG/VTSI which has been prepared by the provider or the program chain information (PGCI) included in the VTSI. However, according to the conventional DVD video standards, it has been impossible for the viewer to play back the motion picture, musical performance, or like content of the VTS in a manner different from what the VMG/VTSI dictates.

The Enhanced DVD of FIG. 40 is shown adapted by the present invention to enable the viewer to enjoy the video program in such a different manner or to add information that is different from the prescriptions of the VMG/VTSI. The ENAV contents of this disk are inaccessible, or irretrievable if accessible, by the DVD player manufactured in conformity with the DVD video specifications, but are accessible and playable by the DVD player specially designed for use therewith.

The ENAV contents include sound data, still-picture data, font text data, motion video data, animation data, etc., in addition to ENAV document for controlling the playback of all such data. The ENAV document describes, in markup or script language, the methods of playback (marking method, procedure of playback, procedure of playback switching, selection of the object for playback, etc.) of the ENAV contents and/or DVD video contents. The markup language in use may be either Hypertext Markup Language/Extensible Hypertext Markup Language (HTML/XHTML) or Synchronized Multimedia Integration Language (SMIL), and the script language may be either European Computer Manufacturers Association (ECMA) script or JavaScript. Various language combinations are possible.

The present invention suggests prerecording of object metadata on the Enhanced DVD as part of the ENAV contents. As in all the foregoing embodiments of the invention, the object metadata is designed to enable the viewer access some predefined information on each object appearing in the DVD video program, by clicking on that object on the display screen. The object metadata may be prerecorded on the disk just as it is on the storage medium 113 of the metadata distributor 101 in the first three embodiments of the invention. Also as in the foregoing embodiments, the object property information included in the object metadata may be omitted wherever possible in order to save the disk surface area required for such metadata recording and to make most of the storage capacity of the disk.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. Metadata for an object in video, comprising first and second pieces of the metadata each including object property information of the object, property identification information for the object property information, and object region information indicating a position of the object in an image,
wherein if the second piece is the same as the first piece in a property of the object property information, the property identification information of the second piece is the same as the property identification information of the first piece and the second piece does not include the property in the object property information of the second piece.

2. The metadata according to claim 1, wherein if the second piece is the same as the first piece in all properties of the object property information, the property identification information of the second piece is the same as the property identification information of the first piece and the second piece does not include the object property information.

3. The metadata according to claim 1, wherein the object property information includes an action script associated with the object,
the property identification information includes action identification information for the action script, and
if the second piece is the same as the first piece in an action to be executed, the action identification information of the second piece is the same as the action identification information of the first piece and the second piece does not include the action script in the object property information.

4. The metadata according to claim 1, wherein the object property information includes object display information for displaying the object,
the property identification information includes display identification information for the object display information, and
if the second piece is the same as the first piece in a display, the display identification information of the second piece is the same as the display identification information of the first piece and the second piece does not include the object display information in the object property information.

5. The metadata according to claim 1, wherein if the second piece is different from the first piece in a property of the object property information, the property identification information of the second piece is the same as the property identification information of the first piece and the second piece includes only the property in the object property information.

6. The metadata according to claim 1, wherein the first and second pieces each include object identification information for the object, and
if the second piece is the same as the first piece in the object region information, the object identification information of the second piece is the same as the object identification information of the first piece and the second piece does not include the object region information.

7. An apparatus for distributing metadata for an object in video, comprising:
a storage unit storing the metadata, the metadata including first and second pieces of the metadata each including object property information of the object, property identification information for the object property information, and object region information indicating a position of the object in an image; and
a metadata distributor sending the first and second pieces to a video player via a network,
wherein if the second piece is the same as the first piece in a property of the object property information, the property identification information of the second piece is the same as the property identification information of the first piece and the second piece does not include the property in the object property information of the second piece.

8. The apparatus according to claim 7, wherein if the second piece is the same as the first piece in all properties of the object property information, the property identification information of the second piece is the same as the property identification information of the first piece and the second piece does not include the object property information.

9. The apparatus according to claim 7, wherein the object property information includes an action script associated with the object,
the property identification information includes action identification information for the action script, and
if the second piece is the same as the first piece in an action to be executed, the action identification information of the second piece is the same as the action identification information of the first piece and the second piece does not include the action script in the object property information.

10. The apparatus according to claim 7, wherein the object property information includes object display information for displaying the object,
the property identification information includes display identification information for the object display information, and
if the second piece is the same as the first piece in a display, the display identification information of the second piece is the same as the display identification information of the first piece and the second piece does not include the object display information in the object property information.

11. The apparatus according to claim 7, wherein if the second piece is different from the first piece in a property of the object property information, the property identification information of the second piece is the same as the property identification information of the first piece and the second piece includes only the property in the object property information.

12. The apparatus according to claim 7, wherein the first and second pieces each include object identification information for the object, and
if the second piece is the same as the first piece in the object region information, the object identification information of the second piece is the same as the object identification information of the first piece and the second piece does not include the object region information.

13. The apparatus according to claim 7, further comprising a second storage unit storing access information including (1) play time of a piece of the metadata and (2) offset indicating a position of the piece of the metadata from a beginning of the metadata,
wherein the metadata distributor determines a piece of the metadata to be distributed based on the access information, and sends the piece determined to the video player, in response to a metadata request by the video player.

14. An apparatus for playing video with metadata for an object in the video, comprising:
a metadata receiver receiving the metadata from a metadata distributor via a network, the metadata including first and second pieces of the metadata each including object property information of the object, property identification information for the object property information, and object region information indicating a position of the object in an image;
a metadata interpreter obtaining, if the property identification information of the second piece is the same as the property identification information of the first piece and the second piece does not include a property of the object property information of the first piece in the object property information of the second piece, the property from the object property information of the first piece, for the object property information of the second piece; and
a player playing the video with the first piece and the second piece including the property obtained.

15. The apparatus according to claim 14, wherein the metadata interpreter obtains, if the property identification information of the second piece is the same as the property identification information of the first piece and the second piece does not include the object property information, the object property information from the first piece, for the second piece, and
the player plays the video with the first piece and the second piece including the object property information obtained.

16. The apparatus according to claim 14, wherein the object property information includes an action script associated with the object,
the property identification information includes action identification information for the action script, and
the metadata interpreter obtains, if the action identification information of the second piece is the same as the action identification information of the first piece and the second piece does not include the action script in the object property information, the action script from the object property information of the first piece, for the second piece.

17. The apparatus according to claim 15, further comprising an script interpreter executing the action script when the object is selected during playing the video.

18. The apparatus according to claim 14, wherein the object property information includes object display information for displaying the object,
the property identification information includes display identification information for the object display information,
the metadata interpreter obtains, if the display identification information of the second piece is the same as the display identification information of the first piece and the second piece does not include the object display information in the object property information, the object display information from the object property information of the first piece, for the second piece, and
the player plays the video with the first piece and the second piece including the object display information obtained.

19. The apparatus according to claim 14, wherein the metadata interpreter creates an object property table including the property identification information and the object property information which are associated with each other, and obtains information not included in the object property information of the second piece from the object property table.

20. The apparatus according to claim 14, wherein the metadata interpreter reconstructs the second piece using the object property information of the first piece.

21. The apparatus according to claim 14, wherein the first and second pieces each include object identification information for the object,
the metadata interpreter obtains, if the object identification information of the second piece is the same as the object identification information of the first piece and the second piece does not include the object region information, the object region information from the object property information of the first piece, for the second piece, and
the player plays the video with the first piece and the second piece including the object region information obtained.

22. A system comprising a metadata distributing device and a video playing device which are connected via a network,
the metadata distributing device includes:
a storage unit storing metadata for an object in video, the metadata including first and second pieces of the metadata each including object property information of the object, property identification information for the object property information, and object region information indicating a position of the object in an image; and
a metadata distributor sending the first and second pieces to a video player via a network,
wherein if the second piece is the same as the first piece in a property of the object property information, the property identification information of the second piece is the same as the property identification information of the first piece and the second piece does not include the property in the object property information of the second piece, and
the video playing device includes:
a metadata receiver receiving the metadata from the metadata distributing device via the network;
a metadata interpreter obtaining, if the property identification information of the second piece is the same as the property identification information of the first piece and the second piece does not include a property of the object property information of the first piece in the object property information of the second piece, the property from the object property information of the first piece, for the object property information of the second piece; and
a player playing the video with the first piece and the second piece including the property obtained.

23. A method of distributing metadata for an object in video, the metadata including first and second pieces of the metadata each including object property information of the object, property identification information for the object property information, and object region information indicating a position of the object in an image, the method comprising:
sending the first and second pieces to a video player via a network,
wherein if the second piece is the same as the first piece in a property of the object property information, the property identification information of the second piece is the same as the property identification information of the first piece and the second piece does not include the property in the object property information of the second piece.

24. A method of playing video with metadata for an object in the video, comprising:
receiving the metadata from a metadata distributor via a network, the metadata including first and second pieces of the metadata each including object property information of the object, property identification information for the object property information, and object region information indicating a position of the object in an image;
obtaining, if the property identification information of the second piece is the same as the property identification information of the first piece and the second piece does not include a property of the object property information of the first piece in the object property information of the second piece, the property from the object property information of the first piece, for the object property information of the second piece; and
playing the video with the first piece and the second piece including the property obtained.

25. A computer program product for distributing metadata for an object in video, the metadata including first and second pieces of the metadata each including object property information of the object, property identification information for the object property information, and object region information indicating a position of the object in an image, the computer program product having a computer readable medium including programmed instructions, wherein the instructions, when executed by a computer, cause the computer to perform:
sending the first and second pieces to a video player via a network,
wherein if the second piece is the same as the first piece in a property of the object property information, the property identification information of the second piece is the same as the property identification information of the first piece and the second piece does not include the property in the object property information of the second piece.

26. A computer program product for playing video with metadata for an object in the video, the computer program product having a computer readable medium including programmed instructions, wherein the instructions, when executed by a computer, cause the computer to perform:
receiving the metadata from a metadata distributor via a network, the metadata including first and second pieces of the metadata each including object property information of the object, property identification information for the object property information, and object region information indicating a position of the object in an image;
obtaining, if the property identification information of the second piece is the same as the property identification information of the first piece and the second piece does not include a property of the object property information of the first piece in the object property information of the second piece, the property from the object property information of the first piece, for the object property information of the second piece; and
playing the video with the first piece and the second piece including the property obtained.
